(19) United States
(12) Patent Application Publication
(10) Pub. No.: US 2024/0205046 A1
(43) Pub. Date: Jun. 20, 2024

(54) METHOD AND APPARATUSES FOR RELIABLE INDUSTRIAL INTERNET OF THINGS TRANSMISSIONS

(71) Applicant: Lenovo (Singapore) Pte. Ltd., New Tech Park (SG)

(72) Inventors: Joachim Löhr, Wiesbaden (DE); Prateek Basu Mallick, Dreieich (DE); Karthikeyan Ganesan, Kronberg im Taunus (DE); Ravi Kuchibhotla, Chicago, IL (US)

(21) Appl. No.: 18/554,543

(22) PCT Filed: Mar. 30, 2022
(86) PCT No.: PCT/IB2022/052983

§ 371 Date: Oct. 9, 2023

Related U.S. Application Data
(60) Provisional application No. 63/173,156, filed on Apr. 9, 2021.

(51) Int. Cl. H04L 12/437; H04W 24/04; H04W 76/16; H04W 92/18

(52) U.S. Cl. CPC H04L 12/437; H04W 24/04; H04W 76/16; H04W 92/18

(57) ABSTRACT

Various aspects of the present disclosure relate to reliable industrial internet of things transmissions. An apparatus is configured to transmit a transport block (“TB”) to a first device over a first communication link, the first communication link comprising a first radio transmission technology interface, detect that the transmission of the TB to the first device over the first communication link failed, and in response to detecting that the transmission of the TB to the first device over the first communication link failed, transmit the TB to a second device over a second communication link, the second communication link comprising a second radio transmission technology interface that is different from the first radio transmission technology interface.

### CROSS-REFERENCE TO RELATED APPLICATIONS

This application claims the benefit of U.S. Provisional Patent Application No. 63/173,156, entitled “RELIABLE INDUSTRIAL INTERNET OF THINGS TRANSMISSIONS” and filed on Apr. 9, 2021, for Joachim Löhr, et al., which is incorporated herein by reference.

### FIELD

The subject matter disclosed herein relates generally to wireless communications and more particularly relates to reliable industrial internet of things transmissions.

### BACKGROUND

In the sidelink evolution, supporting ultra-reliable low latency communications (“URLLC”) features like mini-slot type transmissions maybe beneficials for industrial internet of things (“IIoT”) type applications requiring lower latency and higher reliability. In the current sidelink release, the configured grant resources are only known between a base station gNB, transmitter (“Tx”) user equipment (“UE”) and the receiving (“Rx”) UE is not aware of the configured grant resource signaled between a base station and Tx UE. Also, the gNB may not identify UEs in the sidelink by mapping source IDs to destination IDs with the cell-radio network temporary identifier (“C-RNTIs”).

For wireless transmissions of EtherCAT frames in a ring topology, a high level of robustness needs to be guaranteed. Transmission errors/failures on the PC5 interface between neighboring nodes/devices need to be recovered to compromise the performances of the applications, which may be important for a fault-proof network.

### BRIEF SUMMARY

Disclosed are solutions for reliable industrial internet of things transmissions. The solutions may be implemented by apparatus, systems, methods, or computer program products.

A first apparatus includes a transceiver that transmits a transport block (“TB”) to a first device over a first communication link, the first communication link using a first radio transmission technology interface, detects that the transmission of the TB to the first device over the first communication link failed, and in response to detecting that the transmission of the TB to the first device over the first communication link failed, transmits the TB to a second device over a second communication link, the second communication link using a second radio transmission technology interface that is different from the first radio transmission technology interface.

A first method transmits a transport block (“TB”) to a first device over a first communication link, the first communication link using a first radio transmission technology interface, detects that the transmission of the TB to the first device over the first communication link failed, and in response to detecting that the transmission of the TB to the first device over the first communication link failed, transmits the TB to a second device over a second communication link, the second communication link using a second radio transmission technology interface that is different from the first radio transmission technology interface.

A second apparatus includes a transceiver that receives a transport block (“TB”) from a first device, the TB intended for a second device communicatively connected to the apparatus and the first device in a ring topology and a processor that determines an identifier for the second device based on the TB. In one embodiment, the transceiver transmits the TB to the identified second device over a new radio (“NR”) Uu interface.

A second method receives a transport block (“TB”) from a first device, the TB intended for a second device communicatively connected to the apparatus and the first device in a ring topology, determines an identifier for the second device based on the TB, and transmits the TB to the identified second device over a new radio (“NR”) Uu interface.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a schematic block diagram illustrating one embodiment of a wireless communication system for reliable industrial internet of things transmissions;

FIG. 2 is a diagram of CG configuration signaling for sidelink;

FIG. 3 depicts a SL-ConfiguredGrantConfig Information Element from 3GPP TS 38.331;

FIG. 4A depicts a ConfiguredGrantConfig Information Element from 3GPP TS 38.331;

FIG. 4B is a continuation of FIG. 4A;

FIG. 5 is a diagram of one embodiment of an Ethernet Frame structure;

FIG. 6A is a diagram of one embodiment of an EtherCAT network with ring topology;

FIG. 6B is a diagram of another embodiment of an EtherCAT network with ring topology;

FIG. 7 is a diagram of an embodiment of a ConfiguredGrantConfig information element;

FIG. 8 is a diagram of one embodiment of a multi-RAT split bearer operation;

FIG. 9 is a block diagram illustrating one embodiment of a user equipment apparatus that may be used for reliable industrial internet of things transmissions;

FIG. 10 is a block diagram illustrating one embodiment of a network apparatus that may be used for reliable industrial internet of things transmissions; and

FIG. 11 is a flowchart diagram illustrating one embodiment of a method for reliable industrial internet of things transmissions.

### DETAILED DESCRIPTION

As will be appreciated by one skilled in the art, aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects.

For example, the disclosed embodiments may be implemented as a hardware circuit comprising custom very-large-scale integration (“VLSI”) circuits or gate arrays, off-the-shelf semiconductors such as logic chips, transistors, or other discrete components. The disclosed embodiments may also be implemented in programmable hardware devices such as field programmable gate arrays, programmable array logic, programmable logic devices, or the like. As another example, the disclosed embodiments may include one or more physical or logical blocks of executable code which may, for instance, be organized as an object, procedure, or function.

Furthermore, embodiments may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In a certain embodiment, the storage devices only employ signals for accessing code.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random-access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain or store a program for use by or in connection with an instruction execution system, apparatus, or device.

Code for carrying out operations for embodiments may be any number of lines and may be written in any combination of one or more programming languages including an object-oriented programming language such as Python, Ruby, Java, Smalltalk, C++, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”), wireless LAN (“WLAN”), or a wide area network (“WAN”), or the connection may be made to an external computer (for example, through the Internet using an Internet Service Provider (“ISP”)).

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

As used herein, a list with a conjunction of “and/or” includes any single item in the list or a combination of items in the list. For example, a list of A, B and/or C includes only A, only B, only C, a combination of A and B, a combination of B and C, a combination of A and C or a combination of A, B and C. As used herein, a list using the terminology “one or more of” includes any single item in the list or a combination of items in the list. For example, one or more of A, B and C includes only A, only B, only C, a combination of A and B, a combination of B and C, a combination of A and C or a combination of A, B and C. As used herein, a list using the terminology “one of” includes one and only one of any single item in the list. For example, “one of A, B and C” includes only A, only B or only C and excludes combinations of A, B and C. As used herein, “a member selected from the group consisting of A, B, and C,” includes one and only one of A, B, or C, and excludes combinations of A, B, and C.” As used herein, “a member selected from the group consisting of A, B, and C and combinations thereof” includes only A, only B, only C, a combination of A and B, a combination of B and C, a combination of A and C or a combination of A, B and C.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. This code may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart diagrams and/or block diagrams.

The code may also be stored in a storage device that can direct a computer, other programmable data processing apparatus, or other devices to function in a particular manner, such that the instructions stored in the storage device produce an article of manufacture including instructions which implement the function/act specified in the flowchart diagrams and/or block diagrams.

The code may also be loaded onto a computer, other programmable data processing apparatus, or other devices to cause a series of operational steps to be performed on the computer, other programmable apparatus, or other devices to produce a computer implemented process such that the code which execute on the computer or other programmable apparatus provide processes for implementing the functions/acts specified in the flowchart diagrams and/or block diagrams.

The flowchart diagrams and/or block diagrams in the Figures illustrate the architecture, functionality, and operation of possible implementations of apparatuses, systems, methods, and program products according to various embodiments. In this regard, each block in the flowchart diagrams and/or block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

Generally, the present disclosure describes systems, methods, and apparatuses for reliable industrial internet of things transmissions. In certain embodiments, the methods may be performed using computer code embedded on a computer-readable medium. In certain embodiments, an apparatus or system may include a computer-readable medium containing computer-readable code which, when executed by a processor, causes the apparatus or system to perform at least a portion of the below described solutions.

In the sidelink evolution, supporting URLLC features like mini-slot type transmissions may be beneficial for IIoT type applications requiring lower latency and higher reliability. In the current sidelink release, the configured grant resources are only known between gNB and Tx UE and the Rx UE is not aware of the configured grant resource signaled between gNB and Tx UE. Also the gNB could not identify UEs in the sidelink by mapping source IDs to destination IDs with the C-RNTIs.

For wireless transmissions of EtherCAT frames in a ring topology, a very high level of robustness needs to be guaranteed. Transmission errors/failures on the PC5 interface between neighboring nodes/devices needs to be quickly recovered in order not to compromise the performances of the applications. It may be essential to have a fault-proof network.

In this disclosure, a new reliability mechanism is disclosed that relies on either the gNB or the sidelink protocol to provide an alternate route to the next node in transport of an EtherCAT frame. The proposed solution takes different approaches to solve the problem. If a transmission link fails, the protocol needs to reroute traffic to keep data flowing. Assuming that multiple technology interfaces may be potentially involved, e.g., NR Uu and NR PC5/Sidelink, a behavior can be envisioned where the NR PC5 interface is in addition to Uu interface communications used to achieve a certain degree of robustness by means of redundancy (e.g., simultaneous transmissions via PC5 and Uu interface).

According to a first embodiment, a Tx UE transmits a SL Transport Block (“TB”)/medium access control (“MAC”) packet data unit (“PDU”) to the gNB, which in turn forwards/transmits the received SL TB to the Rx UE via the Uu interface, if the transmission of the SL TB over the PC5 interface to the Rx UE is not successful. In one embodiment, a new MAC control element (“CE”) is used that contains the SL TB/MAC PDU intended for transmission to the “next” node. The new UL MAC CE is of variable size and is identified by a reserved logical channel ID.

In one embodiment, a new transmission failure indication from Tx UE to gNB, e.g., transmission failure has occurred on the PC5 for the SL transmission on the allocated SL resources. In one embodiment, the gNB may, in response to receiving a “transmission failure indication” from a SL node/device, start to transmit an Ethernet frame/data packet to the next intended node, e.g., a node that is next in the topology to the node from which the transmission failure indication was received

According to one embodiment, a configured grant (“CG”) configuration allocates/reserves transmission resources with a given periodicity, wherein the amount of transmission resources can vary for each configured grant transmission opportunity. In one embodiment, an offset is used to determine the transport block size of a given configured grant allocation. In one embodiment, the “starting” transport block size of the first configured grant allocation is signaled within the CG configuration or respectively within the CG activation downlink control information (“DCI”). In certain embodiments, a transport block size (“TBS”) offset is signaled/configured that indicates the delta of the transport block sizes associated with two consecutive CG allocations/resources. In one embodiment, a formula defines the transport block size for each CG transmission occasion. Similar to the formula in TS38.321 for determining the configured grant occasions, a formula is used to define the associated TB sizes.

In one embodiment, a multi-RAT split bearer is used for the transmission of Ethernet frames where the two legs/radio link control (“RLC”) bearer belong to different radio access technologies (“RATs”).

According to another embodiment, a SL Tx UE switches the SL cast type for the situation where a SL transmission is determined as unsuccessful. In one embodiment, a Tx UE initially transmits a SL TB, e.g., containing an EtherCAT frame, in a unicast transmission mode over an established SL unicast link to the receiving UE. In one embodiment, upon detecting that the transmission was not successful, the Tx UE (re)transmits the SL TB in a groupcast transmission mode. In one embodiment, the Tx UE includes in the SL transmission containing the SL TB an identifier that identifies the UE/device for which the SL TB is intended. In one embodiment, the groupcast message, including the SL TB, may contain an information field that indicates that the data should be relayed to the mentioned L2 destination ID. In one embodiment, the Tx UE forms a new SL PDU based on the SL TB that was initially transmitted over the unicast link. In such an embodiment, the MAC header may need to be updated to “generate” a groupcast transmission, e.g., a destination ID field needs to be updated. In one embodiment, new header information is added to identify that this packet should be relayed to a destination ID.

In one embodiment, a SL Tx device/node has some logical connection with a first device/node as well as a logical connection with a second device/node. In one example, the first device/node is the subsequent node/device within the topology, whereas the second node/device has the function of a “back-up” node, which is enabled for cases where a transmission failure occurred for SL transmission(s) to the first node/device.

In one embodiment, a UE, e.g. in a ring topology, is determined/selected as a master node. In such an embodiment, the master node selects the technology interface for the transmission of the Ethernet/EtherCAT frames to the subsequent devices/node, e.g., via NR Uu or NR PC5. In one embodiment, the mapping functionality of EtherCAT frame(s) to PC5 or Uu bearer is done within the master node. Quality of service (“QoS”) class identifier (“QCI”) to PC5 QOS identifier (“PQI”) mapping may be done in the master device. In one embodiment, an SL group is comprised of nodes in a ring topology. In such an embodiment, the master node of the SL group sends an EtherCAT frame by a groupcast transmission to the group. In further embodiments, sidelink control information (“SCI”) includes the group ID information and some additional ID of the node within the group which is the intended recipient. In such an embodiment, each node is preconfigured with the ID of the “next” node, which is signaled within the SCI. In one embodiment, each node is (pre)configured with an identity, which is used for determining whether a data packet should be decoded and/or processed. In such an embodiment, the ID, e.g., source ID, indicates to each node in a system, e.g., ring topology, whether it should act on the Ethernet/EtherCAT frame. In one embodiment, the node(s) for which the source ID that is signaled within the SCI matches the preconfigured identity decodes the SL TB and processes the Ethernet frame, e.g., by reading and/or writing the frame.

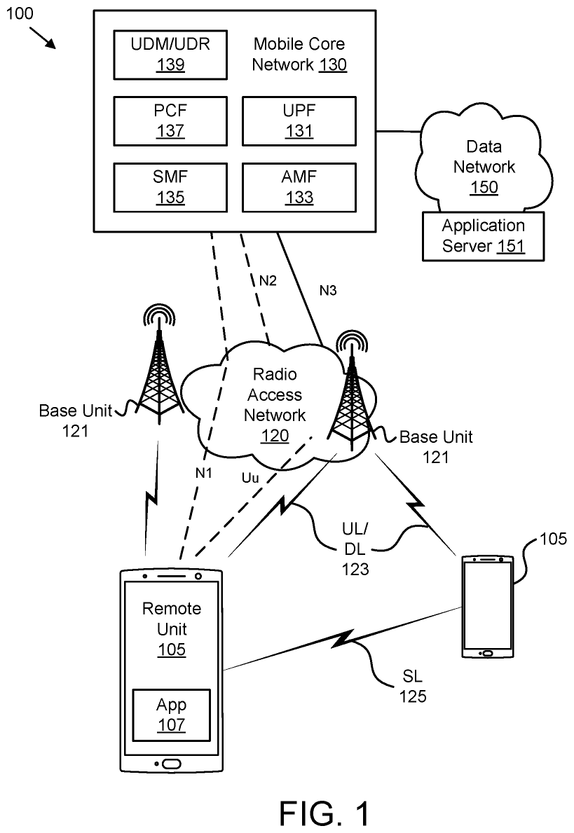

FIG. 1 depicts a wireless communication system 100 supporting reliable industrial internet of things transmissions, according to embodiments of the disclosure. In one embodiment, the wireless communication system 100 includes at least one remote unit 105, a radio access network (“RAN”) 120, and a mobile core network 130. The RAN 120 and the mobile core network 130 form a mobile communication network. The RAN 120 may be composed of a base unit 121 with which the remote unit 105 communicates using wireless communication links 115. Even though a specific number of remote units 105, base units 121, wireless communication links 115, RANs 120, and mobile core networks 130 are depicted in FIG. 1, one of skill in the art will recognize that any number of remote units 105, base units 121, wireless communication links 115, RANs 120, and mobile core networks 130 may be included in the wireless communication system 100.

In one implementation, the RAN 120 is compliant with the 5G system specified in the Third Generation Partnership Project (“3GPP”) specifications. For example, the RAN 120 may be a New Generation Radio Access Network (“NG-RAN”), implementing NR RAT and/or 3GPP Long-Term Evolution (“LTE”) RAT. In another example, the RAN 120 may include non-3GPP RAT (e.g., Wi-Fi® or Institute of Electrical and Electronics Engineers (“IEEE”) 802.11-family compliant WLAN). In another implementation, the RAN 120 is compliant with the LTE system specified in the 3GPP specifications. More generally, however, the wireless communication system 100 may implement some other open or proprietary communication network, for example Worldwide Interoperability for Microwave Access (“WiMAX”) or IEEE 802.16-family standards, among other networks. The present disclosure is not intended to be limited to the implementation of any particular wireless communication system architecture or protocol.

In one embodiment, the remote units 105 may include computing devices, such as desktop computers, laptop computers, personal digital assistants (“PDAs”), tablet computers, smart phones, smart televisions (e.g., televisions connected to the Internet), smart appliances (e.g., appliances connected to the Internet), set-top boxes, game consoles, security systems (including security cameras), vehicle on-board computers, network devices (e.g., routers, switches, modems), or the like. In some embodiments, the remote units 105 include wearable devices, such as smart watches, fitness bands, optical head-mounted displays, or the like. Moreover, the remote units 105 may be referred to as the UEs, subscriber units, mobiles, mobile stations, users, terminals, mobile terminals, fixed terminals, subscriber stations, user terminals, wireless transmit/receive unit (“WTRU”), a device, or by other terminology used in the art. In various embodiments, the remote unit 105 includes a subscriber identity and/or identification module (“SIM”) and the mobile equipment (“ME”) providing mobile termination functions (e.g., radio transmission, handover, speech encoding and decoding, error detection and correction, signaling and access to the SIM). In certain embodiments, the remote unit 105 may include a terminal equipment (“TE”) and/or be embedded in an appliance or device (e.g., a computing device, as described above).

The remote units 105 may communicate directly with one or more of the base units 121 in the RAN 120 via uplink (“UL”) and downlink (“DL”) communication signals. Furthermore, the UL and DL communication signals may be carried over the wireless communication links 123. Here, the RAN 120 is an intermediate network that provides the remote units 105 with access to the mobile core network 130.

In some embodiments, the remote units 105 communicate with an application server via a network connection with the mobile core network 130. For example, an application 107 (e.g., web browser, media client, telephone and/or Voice-over-Internet-Protocol (“VoIP”) application) in a remote unit 105 may trigger the remote unit 105 to establish a protocol data unit (“PDU”) session (or other data connection) with the mobile core network 130 via the RAN 120. The mobile core network 130 then relays traffic between the remote unit 105 and the application server (e.g., the content server 151 in the packet data network 150) using the PDU session. The PDU session represents a logical connection between the remote unit 105 and the User Plane Function (“UPF”) 131.

In order to establish the PDU session (or PDN connection), the remote unit 105 must be registered with the mobile core network 130 (also referred to as “attached to the mobile core network” in the context of a Fourth Generation (“4G”) system). Note that the remote unit 105 may establish one or more PDU sessions (or other data connections) with the mobile core network 130. As such, the remote unit 105 may have at least one PDU session for communicating with the packet data network 150, e.g., representative of the Internet. The remote unit 105 may establish additional PDU sessions for communicating with other data networks and/or other communication peers.

In the context of a 5G system (“5GS”), the term “PDU Session” a data connection that provides end-to-end (“E2E”) user plane (“UP”) connectivity between the remote unit 105 and a specific Data Network (“DN”) through the UPF 131. A PDU Session supports one or more Quality of Service (“QoS”) Flows. In certain embodiments, there may be a one-to-one mapping between a QoS Flow and a QoS profile, such that all packets belonging to a specific QoS Flow have the same 5G QoS Identifier (“5Q1”).

In the context of a 4G/LTE system, such as the Evolved Packet System (“EPS”), a Packet Data Network (“PDN”) connection (also referred to as EPS session) provides E2E UP connectivity between the remote unit and a PDN. The PDN connectivity procedure establishes an EPS Bearer, i.e., a tunnel between the remote unit 105 and a Packet Gateway (“PGW”, not shown) in the mobile core network 130. In certain embodiments, there is a one-to-one mapping between an EPS Bearer and a QoS profile, such that all packets belonging to a specific EPS Bearer have the same QoS Class Identifier (“QCI”).

The base units 121 may be distributed over a geographic region. In certain embodiments, a base unit 121 may also be referred to as an access terminal, an access point, a base, a base station, a Node-B (“NB”), an Evolved Node B (abbreviated as eNodeB or “eNB,” also known as Evolved Universal Terrestrial Radio Access Network (“E-UTRAN”) Node B), a 5G/NR Node B (“gNB”), a Home Node-B, a relay node, a RAN node, or by any other terminology used in the art. The base units 121 are generally part of a RAN, such as the RAN 120, that may include one or more controllers communicably coupled to one or more corresponding base units 121. These and other elements of radio access network are not illustrated but are well known generally by those having ordinary skill in the art. The base units 121 connect to the mobile core network 130 via the RAN 120.

The base units 121 may serve a number of remote units 105 within a serving area, for example, a cell or a cell sector, via a wireless communication link 123. The base units 121 may communicate directly with one or more of the remote units 105 via communication signals. Generally, the base units 121 transmit DL communication signals to serve the remote units 105 in the time, frequency, and/or spatial domain. Furthermore, the DL communication signals may be carried over the wireless communication links 123. The wireless communication links 123 may be any suitable carrier in licensed or unlicensed radio spectrum. The wireless communication links 123 facilitate communication between one or more of the remote units 105 and/or one or more of the base units 121. Note that during NR-U operation, the base unit 121 and the remote unit 105 communicate over unlicensed radio spectrum.

In one embodiment, the mobile core network 130 is a 5GC or an Evolved Packet Core (“EPC”), which may be coupled to a packet data network 150, like the Internet and private data networks, among other data networks. A remote unit 105 may have a subscription or other account with the mobile core network 130. Each mobile core network 130 belongs to a single public land mobile network (“PLMN”). The present disclosure is not intended to be limited to the implementation of any particular wireless communication system architecture or protocol.

The mobile core network 130 includes several network functions (“NFs”). As depicted, the mobile core network 130 includes at least one UPF 131. The mobile core network 130 also includes multiple control plane (“CP”) functions including, but not limited to, an Access and Mobility Management Function (“AMF”) 133 that serves the RAN 120, a Session Management Function (“SMF”) 135, a Network Exposure Function (“NEF”) 136, a Policy Control Function (“PCF”) 137, a Unified Data Management function (“UDM”) and a User Data Repository (“UDR”).

The UPF(s) 131 is responsible for packet routing and forwarding, packet inspection, QoS handling, and external PDU session for interconnecting Data Network (DN), in the 5G architecture. The AMF 133 is responsible for termination of NAS signaling, NAS ciphering & integrity protection, registration management, connection management, mobility management, access authentication and authorization, security context management. The SMF 135 is responsible for session management (i.e., session establishment, modification, release), remote unit (i.e., UE) IP address allocation & management, DL data notification, and traffic steering configuration for UPF for proper traffic routing.

The NEF 136 is responsible for making network data and resources easily accessible to customers and network partners. Service providers may activate new capabilities and expose them through APIs. These APIs allow third-party authorized applications to monitor and configure the network's behavior for a number of different subscribers (i.e., connected devices with different applications). The PCF 137 is responsible for unified policy framework, providing policy rules to CP functions, access subscription information for policy decisions in UDR.

The UDM is responsible for generation of Authentication and Key Agreement (“AKA”) credentials, user identification handling, access authorization, subscription management. The UDR is a repository of subscriber information and can be used to service a number of network functions. For example, the UDR may store subscription data, policy-related data, subscriber-related data that is permitted to be exposed to third party applications, and the like. In some embodiments, the UDM is co-located with the UDR, depicted as combined entity “UDM/UDR” 139.

In various embodiments, the mobile core network 130 may also include an Authentication Server Function (“AUSF”) (which acts as an authentication server), a Network Repository Function (“NRF”) (which provides NF service registration and discovery, enabling NFs to identify appropriate services in one another and communicate with each other over Application Programming Interfaces (“APIs”)), or other NFs defined for the 5GC. In certain embodiments, the mobile core network 130 may include an authentication, authorization, and accounting (“AAA”) server.

In various embodiments, the mobile core network 130 supports different types of mobile data connections and different types of network slices, wherein each mobile data connection utilizes a specific network slice. Here, a “network slice” refers to a portion of the mobile core network 130 optimized for a certain traffic type or communication service. A network instance may be identified by a single-network slice selection assistance information (“S-NSSAI,”) while a set of network slices for which the remote unit 105 is authorized to use is identified by network slice selection assistance information (“NSSAI”).

Here, “NSSAI” refers to a vector value including one or more S-NSSAI values. In certain embodiments, the various network slices may include separate instances of network functions, such as the SMF 135 and UPF 131. In some embodiments, the different network slices may share some common network functions, such as the AMF 133. The different network slices are not shown in FIG. 1 for ease of illustration, but their support is assumed. Where different network slices are deployed, the mobile core network 130 may include a Network Slice Selection Function (“NSSF”) which is responsible for selecting of the Network Slice instances to serve the remote unit 105, determining the allowed NSSAI, determining the AMF set to be used to serve the remote unit 105.

Although specific numbers and types of network functions are depicted in FIG. 1, one of skill in the art will recognize that any number and type of network functions may be included in the mobile core network 130. Moreover, in an LTE variant where the mobile core network 130 comprises an EPC, the depicted network functions may be replaced with appropriate EPC entities, such as a Mobility Management Entity (“MME”), a Serving Gateway (“SGW”), a PGW, a Home Subscriber Server (“HSS”), and the like. For example, the AMF 133 may be mapped to an MME, the SMF 135 may be mapped to a control plane portion of a PGW and/or to an MME, the UPF 131 may be mapped to an SGW and a user plane portion of the PGW, the UDM/UDR 139 may be mapped to an HSS, etc.

In various embodiments, the remote units 105 may communicate directly with each other (e.g., device-to-device communication) using SL communication links 125. Here, SL transmissions may occur on SL resources. The remote units 105 implement SL HARQ processes for at least some data transferred over SL communication signals 125, as discussed in greater detail below.

While FIG. 1 depicts components of a 5G RAN and a 5G core network, the described embodiments apply to other types of communication networks and RATs, including IEEE 802.11 variants, Global System for Mobile Communications (“GSM”, i.e., a 2G digital cellular network), General Packet Radio Service (“GPRS”), UMTS, LTE variants, CDMA 2000, Bluetooth, ZigBee, Sigfox, and the like.

In the following descriptions, the term “gNB” is used for the base station but it is replaceable by any other radio access node, e.g., RAN node, eNB, Base Station (“BS”), Access Point (“AP”), NR, etc. Further the operations are described mainly in the context of 5G NR. However, the proposed solutions/methods are also equally applicable to other mobile communication systems supporting reliable industrial internet of things transmissions.

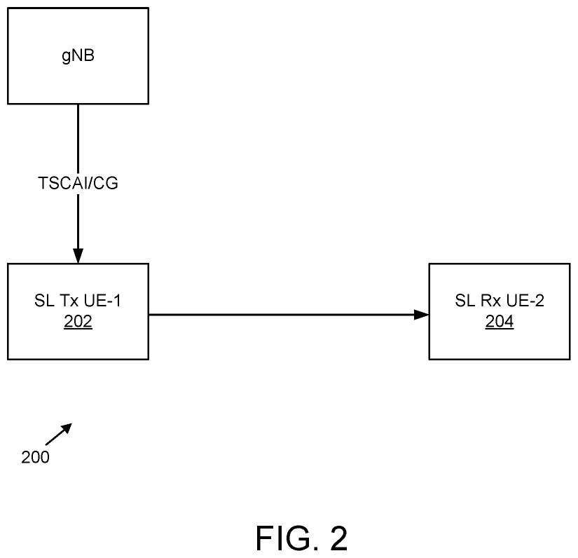

As shown in FIG. 2, in IIoT/URLLC, in one embodiment, periodic cyclic traffic is one of the key aspects, which means there is a reply from the Rx UE 204 at a predefined offset after the transmission from the Tx UE 202. Such aspect may be exploited by providing cyclic configured grant to the UEs 202, 204. In one embodiment, the Rx UE 204 does not know the CG configuration nor the time sensitive communication assistance information (“TSCAI”) that corresponds to the Tx UE 202. In this disclosure, the configuration for cyclic configured grant, physical sidelink feedback channel (“PSFCH”)/physical uplink control channel (“PUCCH”) resource corresponding to each UE transmission, and activation by group common DCI is disclosed.

Table 1 below outlines the sidelink configuration grant features:

TABLE 1
Sidelink configured grant

| CG features | Rel.16 I-IOT (URLLC) | Rel.16 NR-U | Rel.16 Sidelink |
|---|---|---|---|
| Multiple CG | Supported | Supported | Supported |
| configurations | | | |
| HARQ process | Associated with the | Decide and reported | Calculated based on |
| number/ID | configured/indicated | by the UE in CG-UCI | equations |
| determination | first TO, calculated | | |
| | based on the equation | | |
| | defined in TS 38.321 | | |
| Management of | Not shared between | Can be shared | Not shared between |
| HARQ process | different CG | between different CG | different CG |
| number/ID among | configurations in the | configurations in the | configurations |
| multiple CG | same BWP | same BWP | |
| configurations | | | |
| RV determination | One of the three RV | Decide and reported | N.A |
| | sequence can be | by the UE in CG-UCI | |
| | configured and | | |
| | associated with TO | | |
| | {0,0,0,0}; {0,3,0,3}; | | |
| | {0,2,3,1} | | |
| Flexible initial | If the CG is configured | Multiple consecutive | N.A |
| transmission | with | potential Tos are | |
| occasion (TO) | Configuredgrantconfig- | configured by cg- | |
| | StartingfromRV0 set to | nrofPUSCH-InSlot- | |
| | ‘off’, the initial | r16 and cg-nrofSlots- | |
| | transmission only starts | r16, can start initial | |
| | at the first TO of the K | transmission at any | |
| | repetitions; otherwise, | Tos depending on the | |
| | the initial transmission | LBT results. | |
| | TO depends on the | | |
| | configured RV | | |
| | sequence and K | | |
| | repetitions. | | |
| Repetition | PUSCH repetition Type | Similar as PUSCH | N.A |
| scheme(s) | A and PUSCH | repetition Type B | |
| | repetition Type B | without supporting | |
| | | segmentation. (no | |
| | | support of cross-slot | |
| | | resource allocation, | |
| | | and if collide with | |
| | | invalid symbol(s), | |
| | | drop the repetition) | |
| CG-Downlink | No support. If Re- | Support, If CG-DFI is | Support, PSFCH and |
| feedback | scheduling UL grant is | not received, UE | PUCCH feedback |
| information (DFI) | not received, UE | assumes NACK. | |
| | assumes ACK. | | |
| CG Re- | No support | Support and always | N.A |
| transmission timer | | configured | |
| CG transmission | Autonomous | Autonomous | N.A |
| failure | transmission. | retransmission. | |
| (MAC PDU has | For a CG, if the MAC | If the MAC PDU is | |
| been generated but | PDU is generated but | generated for a CG, | |
| fails to transmit) | the CG is de- | but LBT failure is | |
| | prioritized, the MAC | indicated by the lower | |
| | PDU can be | layer, the HARQ | |
| | autonomously | process is considered | |
| | transmitted using the | as pending. The TB | |
| | next CG occasion | can be retransmitted | |
| | associated with the | using a configured | |
| | same HARQ process | grant belonging the | |
| | ID, if no retransmission | same or different | |
| | grant is scheduled by | configured grant | |
| | the gNB. | configuration, as long | |
| | | as they have the same | |
| | | TBS. | |
| CG Retransmission | Retransmission is | Retransmission can be | Retransmission is |
| | scheduled by the gNB | scheduled by the gNB | scheduled by the gNB |
| | with CS-RNTI. | with CS-RNTI. | |
| | | Autonomous | |
| | | retransmission use | |
| | | configured grants: for | |
| | | a HARQ process, if | |
| | | configuredGrantTimer | |
| | | is running while cg- | |
| | | Retransmission Timer | |
| | | is not running, e.g., no | |
| | | DFI received, the TB | |
| | | can be retransmitted | |
| | | using a configured | |
| | | grant belonging the | |
| | | same or different | |
| | | configured grant | |
| | | configuration, as long | |
| | | as they are with the | |
| | | same TBS. | |

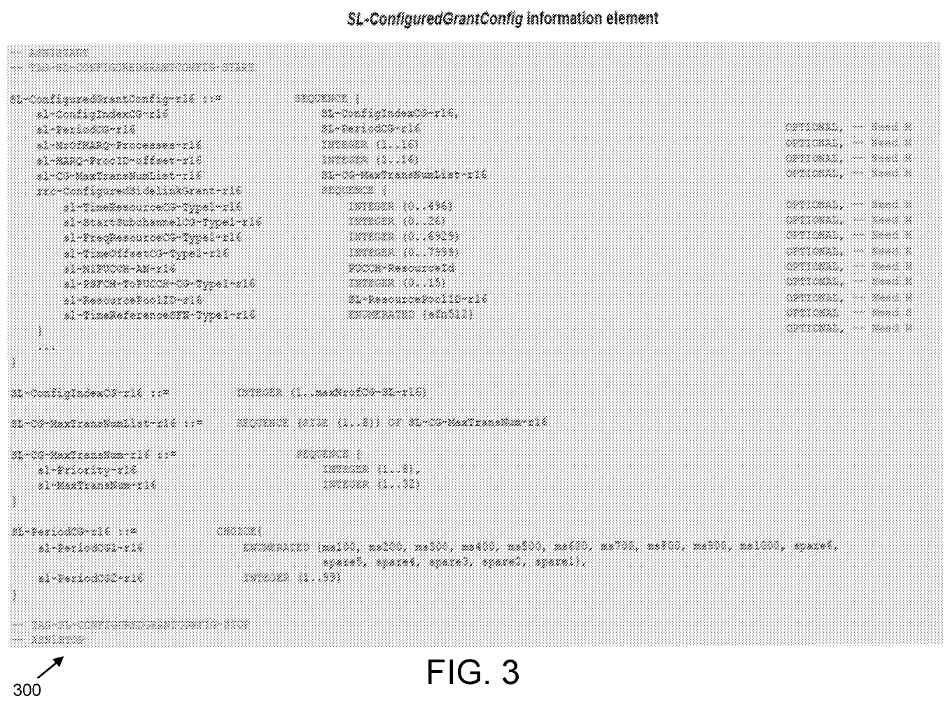

FIG. 3 depicts a SL-ConfiguredGrantConfig Information Element 300 from 3GPP TS 38.331.

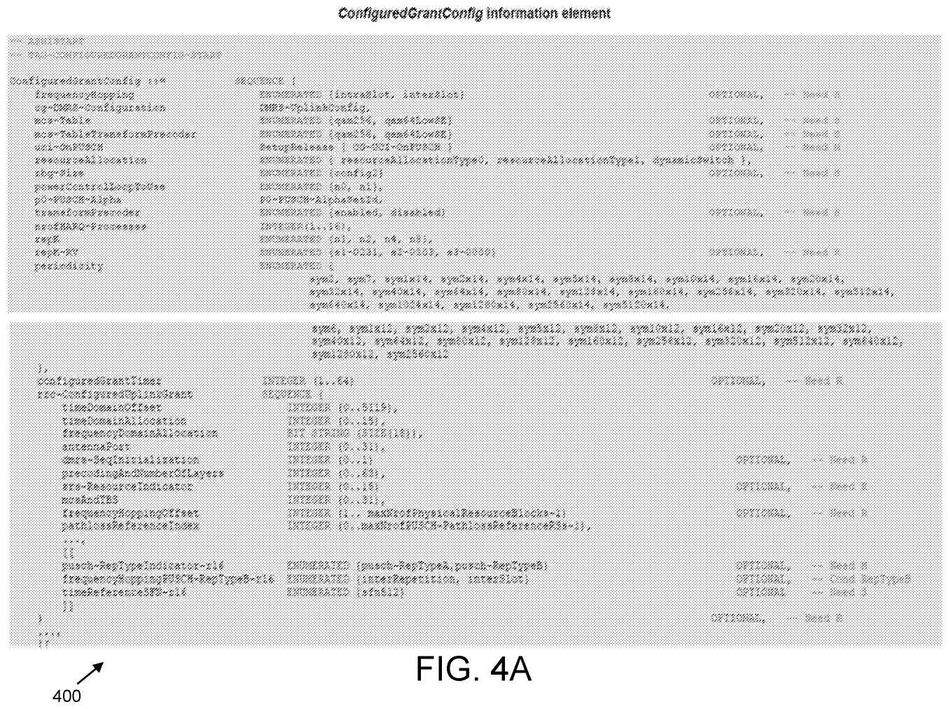

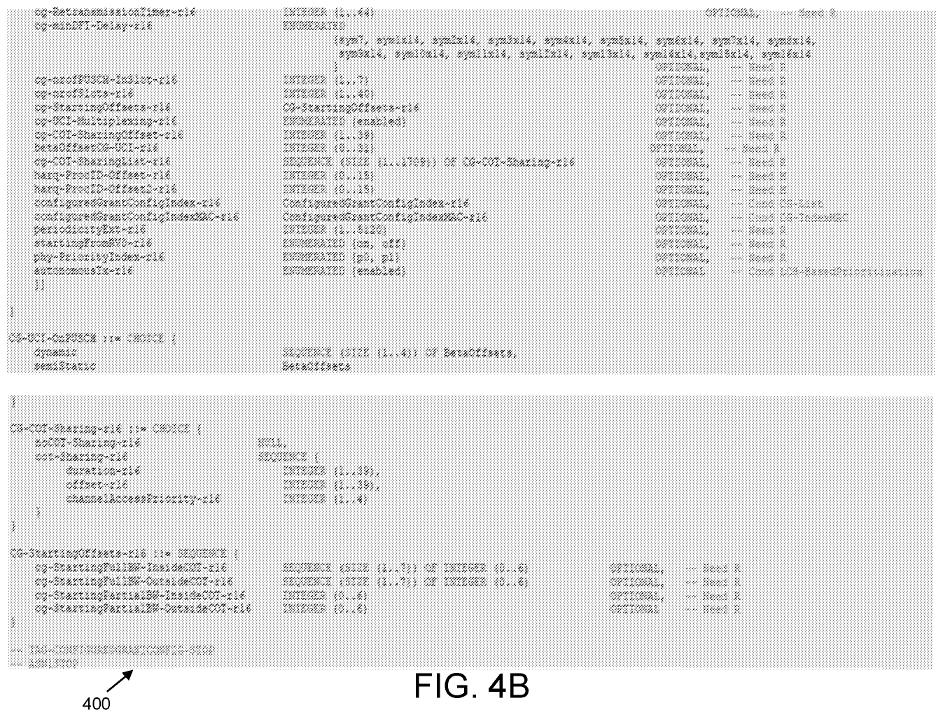

FIGS. 4A-4B depict a ConfiguredGrantConfig Information Element 400 from 3GPP TS 38.331.

Regarding sidelink resource allocation, e.g., according to 3GPP TS 38.214, in sidelink resource allocation mode 1:
for physical shared sidelink channel (“PSSCH”) and physical shared control channel (“PSCCH”) transmission, dynamic grant, configured grant type 1 and configured grant type 2 are supported. The configured grant Type 2 sidelink transmission is semi-persistently scheduled by a SL grant in a valid activation DCI.

Regarding resource allocation in the time domain, in one embodiment, the UE transmits the PSSCH in the same slot as the associated PSCCH. Inn such an embodiment, the minimum resource allocation unit in the time domain is a slot. The UE may transmit the PSSCH in consecutive symbols within the slot, subject to the following restrictions:
The UE may not transmit PSSCH in symbols that are not configured for sidelink. A symbol is configured for sidelink, according to higher layer parameters startSLsymbols and lengthSLsymbols, where startSLsymbols is the symbol index of the first symbol of lengthSLsymbols consecutive symbols configured for sidelink.
Within the slot, PSSCH resource allocation starts at symbol startSLsymbols+1.
The UE may not transmit PSSCH in symbols that are configured for use by PSFCH, if PSFCH is configured in this slot.
The UE may not transmit PSSCH in the last symbol configured for sidelink.
The UE may not transmit PSSCH in the symbol immediately preceding the symbols which are configured for use by PSFCH, if PSFCH is configured in this slot.

In sidelink resource allocation mode 1:
For sidelink dynamic grant, the PSSCH transmission is scheduled by a DCI format 3_0.
For sidelink configured grant type 2, the configured grant is activated by a DCI format 3_0.
For sidelink dynamic grant and sidelink configured grant type 2:
   The “Time gap” field value m of the DCI format 3_0 provides an index m+1 into a slot offset table. That table is given by higher layer parameter timeGapFirstSidelinkTransmission and the table value at index m+1 will be referred to as slot offset K_{SL}.
   The slot of the first sidelink transmission scheduled by the DCI is the first SL slot of the corresponding resource pool that starts not earlier than T_{DL}−T_{TA2}+K_{SL}×T slot where T_{DL} is starting time of the downlink slot carrying the corresponding DCI, T_{TA} is the timing advance value corresponding to the timing advance group (“TAG”) of the serving cell on which the DCI is received and K_{SL} is the slot offset between the slot DCI and the first sidelink transmission scheduled by DCI and Tₛₗₒₜ is the SL slot duration.
For sidelink configured grant type 1:
   The slot of the first sidelink transmissions follows the higher layer configuration.

In one embodiment, regarding resource allocation in frequency domain, the resource allocation unit in the frequency domain is the sub-channel. The sub-channel assignment for sidelink transmission may be determined using the “Frequency resource assignment” field in the associated SCI.

In one embodiment, the lowest sub-channel for sidelink transmission is the sub-channel on which the lowest PRB of the associated PSCCH is transmitted. If a PSSCH scheduled by a PSCCH would overlap with resources containing the PSCCH, in one embodiment, the resources corresponding to a union of the PSCCH that scheduled the PSSCH and associated PSCCH demodulation reference signal (“DM-RS”) are not available for the PSSCH.

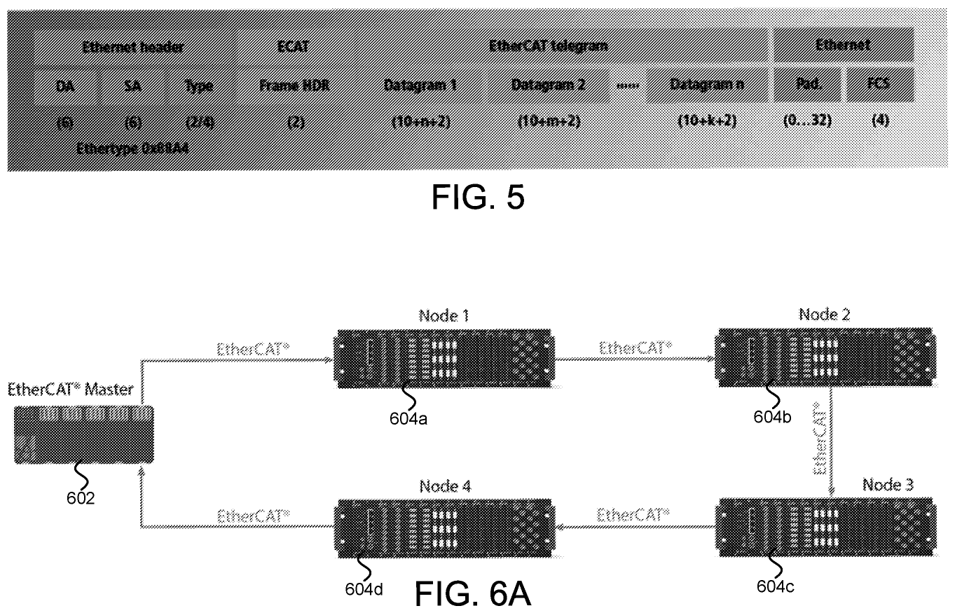

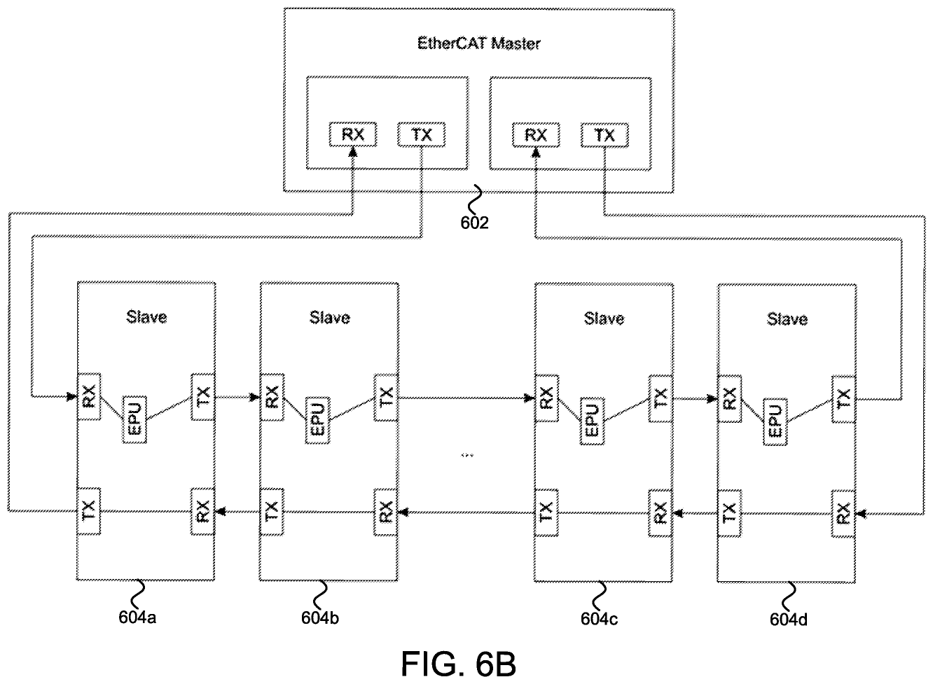

FIG. 5 depicts one embodiment of an ethernet frame structure. EtherCAT is a real-time Ethernet communication technology and is included as a part of the ISO standards. It supports a multitude of network topologies, including line, tree, ring, star, or any combination. This disclosure is mostly related, but not limited to, the ring topology as depicted in FIGS. 6A and 6B, which each depicts an EtherCAT network with ring topology.

The system includes one master node 602 and N slave nodes 604a-d that are connected by the standard Ethernet cable. The master 602 cyclically sends a standard Ethernet frame containing several sub-telegrams or messages (e.g., as formatted according to the Ethernet frame structure of FIG. 5) to slaves 604a-n. The frame transmits through all slaves 604a-n. As the frame passes through slaves 604a-n on the fly, every slave 604a-n is responsible for reading or/and writing the frame. Specifically, each slave 604a-n distinguishes sub-telegrams addressed to itself by address parameter in the header, then takes an action specified by command parameter (read and/or write data) in the header without buffering a frame. For those sub-telegrams that are not addressed to a slave 604a-n, the slave 604a-n only needs to forward them. After the last slave 604a-n in the topology transmits the frame back to the master 602, the next cycle starts again.

The EtherCAT master device 602 is the only device allowed to transmit data across the network. The master 602 is the only device in an EtherCAT segment that is allowed to send messages. The slaves 604a-n can add data and send the frame along, but they cannot create new messages on their own. These frames are received by the EtherCAT slave devices/nodes 604a-n that it is addressed to. The slave devices/nodes 604a-n process data and add back whatever was requested by the master and send the frame along to the next node in the ring. The next slave device/node 604a-n does exactly the same thing, taking in the data intended for it, putting the required data back into the EtherCAT frame, and sending it along to the next node.

As used herein, EtherCAT is Industrial Ethernet that utilizes standard frames and the physical layer as defined in the Ethernet standard IEEE 802.3. However, it also addresses the specific demands faced in the automation industry, where there are hard real-time requirements with deterministic response times. The system is usually made up of many nodes, each only having a small amount of cyclic process data. Hardware costs are even more important than in IT and office applications.

The above requirements make using a standard Ethernet network at the field level practically impossible. If an individual Ethernet telegram is used for each node, the effective data rate sinks significantly for just a few bytes of cyclic process data: the shortest Ethernet telegram is 84 bytes long (including the Inter Frame Gap), of which 46 bytes can be used for process data. For example, if a drive sends 4 bytes of process data for the actual position and status information and receives 4 bytes of data for the target position and control information, the effective data rate for both telegrams sinks to 4/84=4.8%. Additionally, the drive usually has a reaction time that triggers the transmission of the actual values after receiving the target values. At the end, not much of the 100 Mbit/s transfer rate remains. Protocol stacks, such as those used in the IT world for routing (e.g., IP) and connection (e.g., TCP), require additional overhead for each node and create further delays through the stack runtimes.

In one embodiment, EtherCAT overcomes the difficulties described in the previous section with its high-performing mode of operation, in which a single frame is usually sufficient to send and receive control data to and from all nodes. The EtherCAT master 602 sends a telegram that passes through each node. Each EtherCAT slave device 604a-n reads the data addressed to it “on the fly,” and inserts its data in the frame as the frame is moving downstream. The frame is delayed only by hardware propagation delay times. The last node in a segment or branch detects an open port and sends the message back to the master using the full duplex feature. The telegram's maximum effective data rate increases to over 90%, and due to the utilization of the full duplex feature, the theoretical effective data rate is even greater than 100 Mbits/s. The EtherCAT master 602 is the only node within a segment allowed to actively send an EtherCAT frame; all other nodes 604a-n merely forward frames downstream. This concept prevents unpredictable delays and guarantees real-time capabilities. The master 602 uses a standard Ethernet Media Access Controller (“MAC”) without an additional communication processor. This allows a master 602 to be implemented on any hardware platform with an available Ethernet port, regardless of which real-time operating system or application software is used. EtherCAT slave devices 604a-n use a so-called EtherCAT Slave Controller (“ESC”) to process frames on the fly and entirely in hardware, making network performance predictable and independent of the individual slave device 604a-n implementation.

For wireless transmissions of EtherCAT frames in a ring topology, where an Ethernet frame containing several EtherCAT datagrams is transmitted through all slave nodes 604a-n, a very high level of robustness needs to be guaranteed. Transmission errors/failures on the PC5 interface between neighboring nodes/devices needs to be quickly recovered in order to not negatively impact the performances of the applications. It is important for a fault-proof network. If a transmission link fails, the protocol needs to reroute traffic to keep data flowing. When the failed node is restored, the protocol automatically closes the temporary link.

In this disclosure, new reliability mechanisms are disclosed that rely on either the gNB or the sidelink to provide an alternate route to the next node in transport of an EtherCAT/SERCOS frame. Although EtherCAT is taken as an example, the embodiments are equally applicable to Industrial Ethernet schemes such as Profinet, etc., as well as schemes using ring topology to distribute ethernet data to nodes wirelessly.

In one embodiment, the claimed solution provides reliability increases by switching from SL PC5 to Uu interface. If the transmission of a SL TB is not successful over the PC5 interface, a SL Tx UE transmits the SL TB/MAC PDU to the gNB, which forwards/transmits the received SL TB to the Rx UE via the Uu interface, e.g., DL transmission. In one embodiment, a new MAC CE is used that contains the SL TB/MAC PDU intended for transmission the “next” node. In one embodiment, the new UL MAC CE is of variable size and is identified by a reserved logical channel ID. In one embodiment, a new transmission failure is indicated from the Tx UE to the gNB, e.g., transmission failure has occurred on the PC5 for the SL transmission on the allocated SL resources. The gNB may, in response to receiving a “transmission failure indication” from a SL node/device, start to transmit an Ethernet frame/data packet to the next intended node, e.g., a node that is next in the topology to the node from which the transmission failure indication was received.

Regarding reliability increases by switching from SL to gNB, in the embodiments below, the term UE is used generically to identify any node which is part of the ring. The UE may or may not have a universal subscriber identity module (“USIM”)/embedded SIM (“eSIM”) embedded within itself and therefore the UE in the current invention also may refer to a ME, i.e., mobile equipment without a USIM/eSIM.

According to one embodiment, in response to determining that the transmission of the SL TB was not successful over the PC5 interface, e.g., receiving a predefined number of negative acknowledgements (“NACK(s)”) on the PSFCH or discontinuous transmissions (“DTX”) from the SL Rx UE, a SL Tx UE, or in general a UE, the Tx UE transmits a SL TB/MAC PDU to the gNB that the Tx UE is in communication with. In one implementation, each node/UE in the ring topology receives resource allocation configurations from a gNB and the identity of this gNB is known to all nodes in the ring.

In one embodiment, in response to the reception of the SL TB, the gNB forwards/transmits the received SL TB to the Rx UE via the Uu interface, e.g., DL transmission. In one embodiment, the motivation for the proposed mechanism, e.g., switching the transmission path/RAT in case of transmission errors on one interface, is to increase the transmission reliability of Ethernet frames/packets having high reliability requirements, e.g., for slave-to-slave communication of EtherCAT frames.

According to one implementation, the SL TB/MAC PDU is transmitted by means of a new MAC CE in the uplink to the gNB. The MAC CE, which is sent in the UL to the gNB, contains the SL TB/MAC PDU intended for transmission on the next node, the SL Rx UE. In one embodiment, the new UL MAC CE can be of variable size and is identified by a reserved logical channel ID. According to a further implementation the MAC CE containing the SL TB may also include an identifier that identifies the destination of the SL TB/MAC PDU. In one embodiment, based on the received identifier within the MAC CE, the gNB knows which RNTI to use for the DL transmission of the MAC CE containing the SL TB.

In one example, the identifier is the Layer 2 destination ID of the Rx UE. In one further example, the MAC CE may contain a field, e.g., in the MAC sub-header, indicating that the corresponding MAC CE may be relayed by the gNB to the UE identified by the identifier. In another implementation, the gNB is aware of the UE/device the SL TB should be forwarded to, e.g., gNB is aware of the fieldbus e.g., EtherCAT topology (e.g., ring topology) and correspondingly knows the device/UE which is next in the topology. In one embodiment, the assumption is that all UEs/devices are in communication with the same gNB, which is likely the case in a factory environment.

According to a further aspect of this embodiment, the new UL MAC CE, which carries a SL TB, is mapped to one scheduling request (“SR”) configuration. In one embodiment, the SR is used for requesting UL-SCH resources for transmission of the new UL MAC CE. In one embodiment, an SR configuration consists of a set of PUCCH resources for SR across different BWPs and cells. In one embodiment, for cases when the transmission of the UL MAC CE containing a SL TB/MAC PDU is triggered, e.g., in response to detecting that the transmission of the SL TB was not successful over the PC5 interface, and the UE has no valid UL resources available, the UE mat, according to one implementation, trigger a SR on the corresponding SR configuration. In such an embodiment, the UE uses contention free random access to seek resources for UL transmission to the gNB—the resources towards contention free random access including one or more of time, frequency, physical random access channel (“PRACH”) preamble—are allocated by the gNB to the UEs of the EtherCAT telegram in a group specific or in a UE specific manner.

In a further embodiment, the SL Tx UE is pre-configured with resources for transferring the SL TB to the gNB. The gNB may preconfigure the resources based on expected round trip time (“RTT”) of the ACK/NACK from the Rx UE. In one embodiment, this obviates the need for the SR in case of latency sensitive traffic. The gNB may pre-configure the resource accounting for N number of RTTs between the SL Tx and Rx UE. The SL Tx UE may further indicate to the gNB receipt of ACK form the SL Rx UE at which instance the gNB can release the preconfigured Uu resource assigned for path switching.

In one embodiment, the UE indicates, upon detecting a transmission failure on the PC5 interface for a SL TB, to the gNB that a transmission failure has occurred on the PC5 for the SL transmission on the allocated SL resources. In one implementation, the transmission failure indication is sent on PUCCH resources (pre)allocated by the gNB. The gNB may, in response to receiving a “transmission failure indication” from a SL node/device, start to transmit an Ethernet frame/data packet to the next intended node, e.g., a node that is next in the topology to the node from which the transmission failure indication was received.

According to one aspect of the embodiment, a SL node/device is configured according to whether it may trigger/transmit a “transmission failure indication” to the gNB in response to detecting a transmission failure on the PC5 interface. In one example such transmission failure indication may be a MAC CE. In one embodiment, the transmission failure MAC CE may be linked to one SR configuration. In one implementation, the SR is associated with a signal indicating to the gNB to initiate reliability mechanisms, and no MAC CE needs to be transmitted. In one embodiment, the timing of the received SR indicates to the gNB implicitly where the transmission failure occurred.

In one embodiment, the SR identifies the location of the failure in the ring and the gNB uses this to transmit the packet to the remainder of the ring. In a further embodiment, the MAC CE is transmitted since the last node that failed to successfully transmit the packet to the next node in the ring, has appended new information bits for further transmission and this is sent to the gNB for transmission in the remainder of the ring.

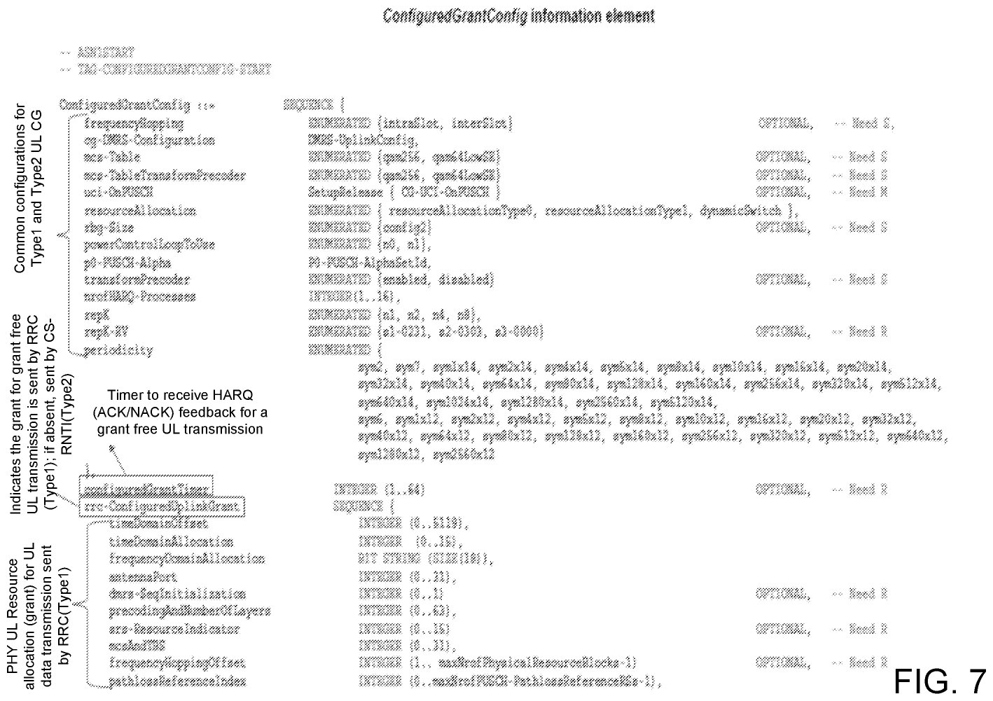

Regarding SL CG grant resources with variable TB sizes, according to one embodiment, a CG configuration, as shown in FIG. 7, allocates/reserves transmission resources with a given periodicity. In one embodiment, the amount of transmission resources can vary for each CG transmission opportunity. In one example, the transmission resources are SL transmission resources; however, the embodiment should not be understood to be only limited to SL (PC5) transmissions, but can also be equally applied to e.g., uplink transmission resources on the Uu interface.

In one embodiment, regarding grant-free scheduling, e.g., CGs, the network entity (e.g., gNB) reserves resources for SL/UL transmissions and informs the UEs of the reserved resources. In one embodiment, when a UE wants to initiate a SL/UL transmission, it directly utilizes the reserved resources without sending an SR and waiting for the subsequent grant/DCI from the gNB. In one embodiment, the MAC entity stores the details of the uplink grant provided by the RRC layer as a configured uplink grant for the indicated serving cell. It initializes or re-initializes the configured uplink grant to start in the symbol according to timeDomainOffset (SFN/Slot) and S(Symbol) (derived from start and length indicator value (“SLIV”)) and reoccurs with a configured periodicity.

In one embodiment, in Type1 grant free transmissions, MAC or L1 cannot make modifications to the grants for any traffic pattern changes, every time a grant needs to be modified it comes from upper layer (RRC reconfiguration). In one embodiment, for type 2 grant free transmissions the SL/UL transmission will start after the UE receives the activate indication in the DCI scrambled by the (SL-)CS-RNTI. In one embodiment, the DCI carries the UL grant information e.g., time-domain resources, frequency-domain resources, modulation and coding scheme (“MCS”), and other related parameters.

In one embodiment, based on the provided grant in the DCI, the UE performs type 2 grant free transmission. In a ring topology, the EtherCAT frames are sent sequentially, according to some predefined order, to the corresponding slave devices (nodes). In one embodiment, once a node receives an EtherCAT frame, the node processes the data and adds back whatever was requested by the master and sends the frame along to the next node in the ring. In one embodiment, the next node does the same thing, taking in the data intended for it, putting the required data back into the EtherCAT frame, and sending it along to the next node.

In one embodiment, the process of read and write performed by a node may result in a variable frame size, e.g., the TBS of the transmission from node N−1 to N might be different to the TBS of the transmission from node N to N+1. According to one implementation of the embodiment, a CG configuration allocates transmission resources semi-persistently with a given periodicity. In one embodiment, the TBS may vary for each configured grant transmission opportunity as the ring is traversed. In one example, an offset, e.g., TB_offset, is used to determine the TBS of a given configured grant allocation.

In one embodiment, the “initial/starting” TBS of the first CG allocation for the first node in the ring, e.g., as given by the formula in TS38.321, is signaled within the CG configuration or respectively within the CG activation DCI. Furthermore, in one embodiment, a TBS_offset is signaled/configured, which indicates the delta of the TBSs associated with two consecutive CG allocations/resources. In one embodiment, the assumption is that a group common CG resource is provided to a group of UEs/nodes, e.g., all nodes within a ring topology, and then each UE/node in the group common CG configuration is assigned with a UE specific CG resource configuration.

For CG type 2, in one embodiment, a group common DCI is used to activate the SL CG. In one embodiment, every node receives the activation DCI and furthermore, every node within the group, e.g., ring topology, knows its corresponding resource allocation. In another example, a formula defines the TBS for each CG transmission occasion. Similar to the formula in TS38.321, as shown below, determining the CG occasions, a formula is used to define the associated TB sizes. For example, based on the position in the ring topology every node is aware of its SL resources, e.g., TB size. In one example, the first node in the ring topology has a SL resource with the initial/starting TB size, e.g., TBSᵢₙᵢₜᵢₐₗ, the second node has the TBS=TBS_initial+(N−1)*TB_{offset}; whereas N is the position of the device/node within the ring topology.

In one embodiment, after an uplink grant is configured for a configured grant Type 1, the MAC entity shall consider sequentially that the N^{th} (N>=0) uplink grant occurs in the symbol for which:

[(SFN×numberOfSlotsPerFrame×numberOfSymbolsPerSlot)+(slot number in the frame×numberOfSymbolsPerSlot)+symbol number in the slot]=(timeReferenceSFN×numberOfSlotsPerFrame×numberOfSymbolsPerSlot+timeDomainOffset×numberOfSymbolsPerSlot+S+N×periodicity)modulo(1024×numberOfSlotsPerFrame×numberOfSymbolsPerSlot).

In one embodiment, the gNB provides a CG resource size with the maximum possible TB size after ascertaining or assuming the number of UEs writing and appending data to the EtherCAT frame—the UEs use padding when necessary.

Regarding multi-RAT split bearer operation, according to one embodiment, a multi-RAT split bearer is used for the transmission of ethernet frames, where the two legs/RLC bearer belong to different RATs. In one example, one RLC bearer is a NR RLC bearer, whereas the second RLC bearer is a PC5 (SL) RLC bearer. The two RLC bearer/legs are associated with a common SL packet data convergence protocol (“PDCP”) entity.

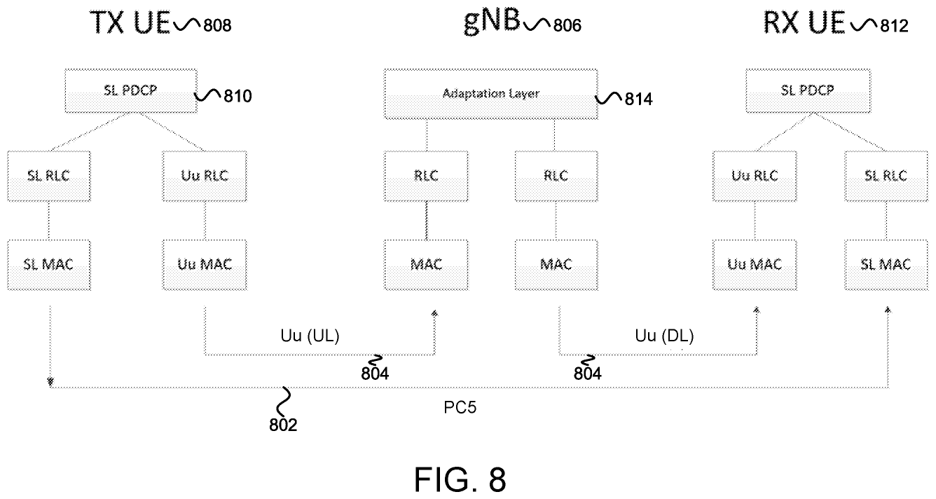

With reference to FIG. 8, initially, in one embodiment, an Ethernet frame/packet is transmitted via the PC5 interface 805. In one embodiment, in response to determining that the transmission of the SL PDCP SDU was not successful, the UE (re)transmit the SL PDCP SDU via the gNB, e.g., Uu interface 804. In one embodiment, the gNB 806, according to one implementation, acts as an L2 relay. In one embodiment, the SL PDCP layer 810 in the Tx UE 808, respectively, the Rx UE 812 also supports the PDCP functionality of a Uu PDCP layer. For example, the “enhanced” SL PDCP layer supports an interface to an Uu RLC layer/protocol.

In one embodiment, both paths are used simultaneously e.g., the Tx UE 808 transmits to the Rx UE 812 via a direct (PC5) path 802 as well as indirect (via gNB 806) paths 804. In one embodiment, the Rx UE 812 removes duplicates at PDCP or in higher layer (if the adaptation layer 814 sits above PDCP, not shown in FIG. 8). In one enhancement of this embodiment, the gNB 806 transmits to the Rx UE 812 only selectively, e.g., upon receiving explicit information from the Tx UE 808 to do so—as mentioned in previous embodiments.

In some embodiments, the LCH configuration, such as SL HARQ feedback enable/disable, can be (pre)configured to be the same across PC5 and Uu. In another implementation, separate LCHs could be defined for Uu to differentiate Uu and Pc5 relaying and the separate LCH in Uu could have similar LCH PC5 configurations. In some embodiments, a translation table could be defined to translate the PC5 LCH configuration to Uu LCH configuration.

Regarding SL cast type switching upon transmission failure, according to another embodiment, the UE switches the SL cast type for the case that a SL transmission is determined to be unsuccessful. According to one implementation, a Tx UE initially transmits a SL TB, e.g., containing an Ethernet frame, in a unicast transmission mode over an established SL resource block (“RB”) to the receiving UE. In one embodiment, upon detecting that the transmission was not successful, the Tx UE (re)transmits the SL TB in a groupcast transmission mode. The SL resource for the groupcast transmission is, in one example, preconfigured by a gNB. Alternatively, in one embodiment, the Tx UE may use mode 2, e.g., select resources autonomously based on sensing, for the groupcast transmission or request resources by the gNB, e.g., mode 1. In one implementation, the Tx UE includes in the SL transmission containing the SL TB an identifier that identifies the UE/device for which the SL TB is intended. In one example, the identifier is an L2 destination ID. In one embodiment, the groupcast message, including the SL TB, may also contain an information field indicating that the data should be relayed to the indicated or identified L2 destination ID.

In one embodiment, in response to having received the groupcast communication, e.g., SL TB for which unicast transmission was unsuccessful, the receiving UE, upon having e.g., decoded the PSSCH transmission and parsed on MAC layer, requests, in one example, SL transmission resources from the gNB to relay/transmit the SL TB to the intended receiver/UE, e.g., identified by the unicast L2 destination ID. In another example, the receiving UE relays/transmits the SL TB to the intended UE using resource allocation mode 2.

According to one implementation of the embodiment, the MAC layer of the Tx UE forms a new SL PDU based on the SL TB that was initially transmitted over the unicast link. In one embodiment, the MAC header may need to be updated to “generate” a groupcast transmission, e.g., groupcast destination ID field needs to be updated. In one embodiment, new control/header information may be added to identify that this packet should be relayed to a unicast destination ID.

In one example, the unicast destination ID is signaled within the MAC layer, e.g., new MAC header element or new MAC CE multiplexed within the SL TB indicating to which recipient/node/UE this TB should be relayed. In one embodiment, HARQ protocol states need to be reset for the HARQ process which was used for unicast transmission. In one embodiment, the HARQ feedback is preconfigured for the groupcast transmission. In one embodiment, it should be noted that some of the SL transmissions parameter are configured per SL logical channel/SL radio bearer, e.g., HARQ mode, MCS, etc.

In one embodiment, when switching the cast type for a SL transmission from SL unicast transmission to a SL groupcast transmission, the SL Tx UE may use a preconfigured SL transmission configuration. In one implementation, when switching from unicast to groupcast transmission, SL HARQ feedback is enabled and the selection of SL HARQ feedback options (option 1 or option 2) follows the number of group members, in case the number of group members are not aware, preconfigured values can be used, which could be provided by the gNB. In another implementation, the Minimum Communication Range (“MCR”) value or Tx UE zone ID could be set to infinity or undefined value from the list and for such case Rx UE does not evaluate the distance based HARQ feedback.

In one embodiment, an L2 destination ID for the above mentioned groupcast transmission is (pre)configured to the UEs that are intended recipients of the telegram message.

According to one implementation of the embodiment, SL Tx UE triggers internally an RLC retransmission of the RLC SDU(s) contained in the SL TB that was not successfully transmitted in the unicast mode. In one embodiment, the Tx UE forms a new SL TB including the RLC SDU retransmission(s) and transmits the SL TB in a groupcast mode as mentioned above. In another example, the SL TX UE triggers internally a retransmission of the PDCP SDU(s) contained in the SL TB, which was not successfully transmitted in the unicast mode. The SL TX generates a new TB according to the SL logical channel prioritization procedure, including the retransmissions of the PDCP SDU(s) that is then transmitted in a groupcast mode.

In one alternative embodiment, the Tx UE transmits the SL TB, upon having detected that the SL transmission to the RX UE was not successful, to the device/UE in the topology that is closest to the UE to which the unicast transmission failed. For example, if SL unicast transmission from device/UE N−1 to N failed, UE N−1 transmits the SL TB to UE/device N+1, thereby indicating that node N+1 shall forward the TB to node N.

In another embodiment, each SL Tx device/node, e.g., in the ring topology, has some logical connection with a first device/node as well as a logical connection with a second device/node. In one example, the first device/node is the subsequent node/device within the topology, whereas the second node/device has the function of a “back-up” node, which is called into action for cases when a transmission failure occurred for SL transmission(s) to the first node/device.

According to one implementation of the embodiment the logical connection is a unicast link that has been established between the two devices/nodes. In one example, the second “back-up” node is selected based on channel conditions. To be more specific, in one example, the criteria for the selection of a “back-up” node is based on the channel conditions between a node and the SL Tx device as well as the channel conditions between the node and the node/device having a first logical connection with the SL Tx device.

In other words, a “back-up” node/device should have good radio conditions for a reception/transmission from/to the SL Tx UE as well as should have good channel conditions for transmission(s) to the first device. In one embodiment, for cases when the SL Tx UE determines a transmission failure for SL Transmission(s) to the first device, it will forward the SL data to the “back-up” node, which acts as a relay node, and forwards the SL data to the first device.

In one implementation, “back-up” nodes are selected by a device/node itself based on channel measurements made by the device or provided to the device. In one embodiment, since a SL Tx UE ‘N−1’ needs to know that its corresponding back-up node has also good radio conditions for a transmission to SL Rx UE ‘N’, channel measurements between the back-up node and SL UE ‘N’ should be provided to SL Tx UE′N−1′. In one embodiment, such assistance information allows a node/UE to learn/update their back-up nodes from time to time. In alternative implementations, a back-up node is determined/selected and configured by a gNB based on channel measurement information provided to the gNB by the different nodes in a ring topology. In another implementation, a back-up node is determined/selected and configured by the EtherCAT master in the form of an alternative topology—a fallback topology.

Regarding embodiments where the gNB is not aware of Ethernet/EtherCAT details, according to further embodiments, one of the devices/UEs, e.g., in a ring topology, is determined/selected as a main node, which implies that the node supports some specific functionality. In one example the node/UE that is configured as the EtherCAT Master is determined/selected as the main node. In one embodiment, the main node/device sends EtherCAT frames, e.g., which it received in the DL from gNB, to the other nodes/UEs, e.g., EtherCAT slave devices.

In one embodiment, the mapping functionality of EtherCAT frame(s) to PC5 or Uu bearer is in one implementation done within the main node. In one embodiment, QCI to PQI mapping is done in the main node/device. According to one implementation, the main device/node selects the technology interface for the transmission of the Ethernet/EtherCAT frames to the subsequent devices/node, e.g., via NR Uu or NR PC5.

In one example, a dynamic technology selection considering the observed radio conditions can be applied to maximize the achieved communication performance. In one embodiment, dynamic selection tries to cope with performance fluctuations that are in particular high in a mobility scenario, e.g., robot devices are moving or robot arms are moving. In one embodiment, based on the available selection parameters reflecting the current situation, the best suited communication technology can be determined. In one embodiment, besides deciding based on instantaneous parameters only, also predictive selection approaches considering long-term performance behavior, e.g., based on knowledge about semi-persistent resource assignments, can be applied. Assuming that multiple technology interfaces may be potentially involved, e.g., NR Uu and NR PC5/Sidelink, a behavior envisioned where the NR PC5 interface is in addition to Uu interface communications used to achieve certain degree of robustness by means of redundancy (simultaneous transmissions via PC5 and Uu interface).

According to one embodiment, the devices/nodes in a system, e.g., ring topology, belong to one SL group. In one embodiment, one of the nodes within the sidelink group is considered a main node. In one example, the main node sends an Ethernet frame by a groupcast transmission to the group of nodes being part of the topology. In one example, the SCI includes the group ID information and also some additional information on which of the nodes within the group is the intended recipient. In one embodiment, only the node that is indicated by the additional ID shall decode the SL TB and process the Ethernet frame, e.g., reading and/or writing the frame.

Specifically, in one embodiment, the node distinguishes sub-telegrams addressed to itself by address parameter in the header, then takes an action specified by command parameter (read and/or write data) in the header. In one embodiment, in response to having processed the Ethernet frame, the node further transmits the processed Ethernet frame to the SL group in a groupcast manner. In one embodiment, the SCI contains the group ID as well as some further ID identifying the “next” node within the group with respect to Ethernet frame processing, i.e., next node in ring topology. In one embodiment, each node is according to one implementation preconfigured with the ID of the “next” node which is signaled within the SCI.

In one implementation, each device/node is (pre)configured with an identity, which is used for determining whether a data packet should be decoded and/or processed. In one example, such identity is a source identity, identifying the transmitter of the data packet, which may be an Ethernet/EtherCAT frame. In other words, the source ID is telling each node in a system, e.g., ring topology, whether it should act on the Ethernet frame.

In one example, the main node sends an Ethernet/EtherCAT frame by a groupcast transmission to the group of nodes being part of the topology. In one embodiment, each node in the group decodes the SL transmission, e.g., SCI accompanying the PSSCH. In one example, only the node(s) for which the source ID signaled within the SCI matches the preconfigured identity shall decode the SL TB and process the Ethernet frame, e.g., reading and/or writing the frame. Specifically, in one embodiment, the node distinguishes sub-telegrams addressed to itself by address parameter in the header, then takes an action specified by command parameter (read and/or write data) in the header. In one embodiment, in response to having processed the Ethernet frame the node further transmits the processed Ethernet frame to the SL group in a groupcast manner. In one embodiment, the SCI contains the group ID as well as the source ID of this node, which will identify the “next node” within the group and which should process the Ethernet/EtherCAT frame, e.g., next node in the ring topology.

In one implementation, a preconfigured list of source ID and destination group ID/destination unicast ID could be assigned for EtherCAT/SERCOS-3 communication. In one embodiment, the mapping between logical addressing in the EtherCAT master is translated and mapped to the destination ID for each node. In one embodiment, one destination group ID is provided for the entire group of nodes receiving one EtherCAT telegram. In one embodiment, each EtherCAT master could have one or more destination group id for one or more EtherCAT telegrams for different nodes and/or with different cycle time.

Regarding always duplicate packets (PC5 and Uu), according to another embodiment, Ethernet/EtherCAT frame(s) are, in addition to being transmitted via the NR PC5 interface, also concurrently transmitted over a second radio interface, e.g., Uu interface. In one embodiment, this approach where devices/UEs, for example, use two radio technologies over two different radio interfaces, e.g., NR Uu interface in addition to the NR PC5 interface communications, is used to achieve a certain degree of robustness by means of redundancy, e.g., for travelling frames in a ring topology.

In one implementation, the decision of whether to send a packet over multiple independent radio interfaces, e.g., using different radio access technologies, is determined on a packet level. In one example, the UE may be configured to transmit selected data packets in a more reliable manner, e.g., over multiple radio interfaces to make sure at least one out of N consecutive frame are transmitted with higher reliability. For example, the foregoing may be achieved by configuring a node/device to submit every N-th Ethernet frame to a Uu as well as PC5 bearer. In one embodiment, the value of N could be configured beforehand for the device/UE to behave correctly. In another example, the decision of whether to use multiple radio technology interfaces, e.g., NR Uu and NR PC5/Sidelink, may be based on channel measurements performed between the transmitter device and the intended recipient device/node.

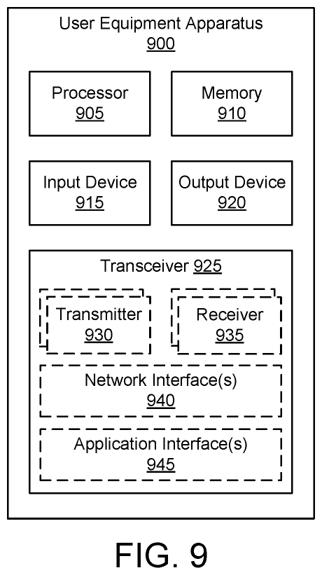

FIG. 9 depicts a user equipment apparatus 900 that may be used for reliable industrial internet of things transmissions, according to embodiments of the disclosure. In various embodiments, the user equipment apparatus 900 is used to implement one or more of the solutions described above. The user equipment apparatus 900 may be one embodiment of a UE, such as the remote unit 105 and/or the UE 205, as described above. Furthermore, the user equipment apparatus 900 may include a processor 905, a memory 910, an input device 915, an output device 920, and a transceiver 925. In some embodiments, the input device 915 and the output device 920 are combined into a single device, such as a touchscreen. In certain embodiments, the user equipment apparatus 900 may not include any input device 915 and/or output device 920. In various embodiments, the user equipment apparatus 900 may include one or more of: the processor 905, the memory 910, and the transceiver 925, and may not include the input device 915 and/or the output device 920.

As depicted, the transceiver 925 includes at least one transmitter 930 and at least one receiver 935. Here, the transceiver 925 communicates with one or more base units 121. Additionally, the transceiver 925 may support at least one network interface 940 and/or application interface 945. The application interface(s) 945 may support one or more APIs. The network interface(s) 940 may support 3GPP reference points, such as Uu and PC5. Other network interfaces 940 may be supported, as understood by one of ordinary skill in the art.

The processor 905, in one embodiment, may include any known controller capable of executing computer-readable instructions and/or capable of performing logical operations. For example, the processor 905 may be a microcontroller, a microprocessor, a central processing unit (“CPU”), a graphics processing unit (“GPU”), an auxiliary processing unit, a field programmable gate array (“FPGA”), a digital signal processor (“DSP”), a co-processor, an application-specific processor, or similar programmable controller. In some embodiments, the processor 905 executes instructions stored in the memory 910 to perform the methods and routines described herein. The processor 905 is communicatively coupled to the memory 910, the input device 915, the output device 920, and the transceiver 925. In certain embodiments, the processor 905 may include an application processor (also known as “main processor”) which manages application-domain and operating system (“OS”) functions and a baseband processor (also known as “baseband radio processor”) which manages radio functions.

In various embodiments, the processor 905 controls the user equipment apparatus 900 to implement the above described UE behaviors for reliable industrial internet of things transmissions.

The memory 910, in one embodiment, is a computer readable storage medium. In some embodiments, the memory 910 includes volatile computer storage media. For example, the memory 910 may include a RAM, including dynamic RAM (“DRAM”), synchronous dynamic RAM (“SDRAM”), and/or static RAM (“SRAM”). In some embodiments, the memory 910 includes non-volatile computer storage media. For example, the memory 910 may include a hard disk drive, a flash memory, or any other suitable non-volatile computer storage device. In some embodiments, the memory 910 includes both volatile and non-volatile computer storage media.

In some embodiments, the memory 910 stores data related to reliable industrial internet of things transmissions. For example, the memory 910 may store parameters, configurations, resource assignments, policies, and the like as described above. In certain embodiments, the memory 910 also stores program code and related data, such as an operating system or other controller algorithms operating on the user equipment apparatus 900, and one or more software applications.

The input device 915, in one embodiment, may include any known computer input device including a touch panel, a button, a keyboard, a stylus, a microphone, or the like. In some embodiments, the input device 915 may be integrated with the output device 920, for example, as a touchscreen or similar touch-sensitive display. In some embodiments, the input device 915 includes a touchscreen such that text may be input using a virtual keyboard displayed on the touchscreen and/or by handwriting on the touchscreen. In some embodiments, the input device 915 includes two or more different devices, such as a keyboard and a touch panel.

The output device 920, in one embodiment, is designed to output visual, audible, and/or haptic signals. In some embodiments, the output device 920 includes an electronically controllable display or display device capable of outputting visual data to a user. For example, the output device 920 may include, but is not limited to, an LCD display, an LED display, an OLED display, a projector, or similar display device capable of outputting images, text, or the like to a user. As another, non-limiting, example, the output device 920 may include a wearable display separate from, but communicatively coupled to, the rest of the user equipment apparatus 900, such as a smart watch, smart glasses, a heads-up display, or the like. Further, the output device 920 may be a component of a smart phone, a personal digital assistant, a television, a table computer, a notebook (laptop) computer, a personal computer, a vehicle dashboard, or the like.

In certain embodiments, the output device 920 includes one or more speakers for producing sound. For example, the output device 920 may produce an audible alert or notification (e.g., a beep or chime). In some embodiments, the output device 920 includes one or more haptic devices for producing vibrations, motion, or other haptic feedback. In some embodiments, all, or portions of the output device 920 may be integrated with the input device 915. For example, the input device 915 and output device 920 may form a touchscreen or similar touch-sensitive display. In other embodiments, the output device 920 may be located near the input device 915.

The transceiver 925 includes at least transmitter 930 and at least one receiver 935. The transceiver 925 may be used to provide UL communication signals to a base unit 121 and to receive DL communication signals from the base unit 121, as described herein. Similarly, the transceiver 925 may be used to transmit and receive SL signals (e.g., V2X communication), as described herein. Although only one transmitter 930 and one receiver 935 are illustrated, the user equipment apparatus 900 may have any suitable number of transmitters 930 and receivers 935. Further, the transmitter(s) 930 and the receiver(s) 935 may be any suitable type of transmitters and receivers. In one embodiment, the transceiver 925 includes a first transmitter/receiver pair used to communicate with a mobile communication network over licensed radio spectrum and a second transmitter/receiver pair used to communicate with a mobile communication network over unlicensed radio spectrum.

In certain embodiments, the first transmitter/receiver pair used to communicate with a mobile communication network over licensed radio spectrum and the second transmitter/receiver pair used to communicate with a mobile communication network over unlicensed radio spectrum may be combined into a single transceiver unit, for example a single chip performing functions for use with both licensed and unlicensed radio spectrum. In some embodiments, the first transmitter/receiver pair and the second transmitter/receiver pair may share one or more hardware components. For example, certain transceivers 925, transmitters 930, and receivers 935 may be implemented as physically separate components that access a shared hardware resource and/or software resource, such as for example, the network interface 940.

In various embodiments, one or more transmitters 930 and/or one or more receivers 935 may be implemented and/or integrated into a single hardware component, such as a multi-transceiver chip, a system-on-a-chip, an ASIC, or other type of hardware component. In certain embodiments, one or more transmitters 930 and/or one or more receivers 935 may be implemented and/or integrated into a multi-chip module. In some embodiments, other components such as the network interface 940 or other hardware components/circuits may be integrated with any number of transmitters 930 and/or receivers 935 into a single chip. In such embodiment, the transmitters 930 and receivers 935 may be logically configured as a transceiver 925 that uses one more common control signals or as modular transmitters 930 and receivers 935 implemented in the same hardware chip or in a multi-chip module.

In one embodiment, the transceiver 925 transmits a transport block (“TB”) to a first device over a first communication link, the first communication link using a first radio transmission technology interface, detects that the transmission of the TB to the first device over the first communication link failed, and in response to detecting that the transmission of the TB to the first device over the first communication link failed, transmits the TB to a second device over a second communication link, the second communication link using a second radio transmission technology interface that is different from the first radio transmission technology interface.

In one embodiment, the first radio transmission technology interface is a new radio (“NR”) sidelink (“SL”) PC5 interface and the second radio transmission technology interface is a NR Uu interface.

In one embodiment, the first device is a user equipment (“UE”) that is communicatively connected to the apparatus and the second device is a base unit that is communicatively connected to the apparatus and one or more additional apparatuses.

In one embodiment, the transceiver 925 transmits the TB to the second device using a new medium access control (“MAC”) control element (“CE”), the MAC CE comprising an identifier for the first device that is the intended recipient of the TB.

In one embodiment, the new MAC CE comprises a field indicating to the second device to forward the TB to the identifier for the first device.

In one embodiment, the processor 905 maps the new MAC CE to a scheduling request (“SR”) configuration for requesting SL resources for transmitting the new MAC CE to the second device.

In one embodiment, the processor 905 triggers the SR in response to determining that the apparatus does not have valid SL resources available for transmitting the new MAC CE to the second device.

In one embodiment, the processor 905 uses a contention free random access to seek resources for transmitting the new MAC CE to the second device.

In one embodiment, the transceiver 925 receives a preconfiguration of resources for transmitting the TB to the second device based on an expected round trip time (“RTT”) for receiving a response from the first device.

In one embodiment, the transceiver 925 transmits, on resources allocated by the second device, an indication to the second device that the transmission of the TB to the first device over the first communication link failed.

In one embodiment, the transmission failure indication comprises a medium access control (“MAC”) control element (“CE”), the MAC CE linked to at least one scheduling request (“SR”) configuration.

In one embodiment, the first communication link and the second communication link are operated by a multi-radio access technology (“RAT”) split bearer, wherein the multi-RAT bearer is comprised of a first new radio (“NR”) radio link control (“RLC”) bearer and a second PC5 RLC bearer.

In one embodiment, the first and second bearers are associated with a common SL packet data convergence protocol (“PDCP”) entity.

In one embodiment, the transceiver 925 transmits the TB over the first communication link and the second communication link simultaneously.

In one embodiment, the transceiver 925 transmits every N^{th} TB over the first communication link and the second communication link simultaneously.

In one embodiment, the transceiver 925 transmits the TB over the first communication link and the second communication link simultaneously in response to channel measurements between the transceiver and the first device indicating transmitting the TB over the first communication link and the second communication link.

In one embodiment, the TB comprises an EtherCAT frame.

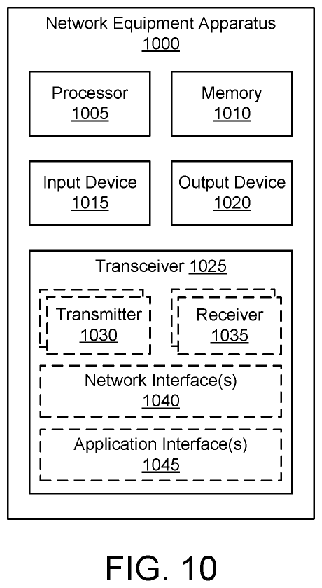

FIG. 10 depicts one embodiment of a network apparatus 1000 that may be used for reliable industrial internet of things transmissions, according to embodiments of the disclosure. In some embodiments, the network apparatus 1000 may be one embodiment of a RAN node and its supporting hardware, such as the base unit 121 and/or gNB, described above. Furthermore, network apparatus 1000 may include a processor 1005, a memory 1010, an input device 1015, an output device 1020, and a transceiver 1025. In certain embodiments, the network apparatus 1000 does not include any input device 1015 and/or output device 1020.

As depicted, the transceiver 1025 includes at least one transmitter 1030 and at least one receiver 1035. Here, the transceiver 1025 communicates with one or more remote units 105. Additionally, the transceiver 1025 may support at least one network interface 1040 and/or application interface 1045. The application interface(s) 1045 may support one or more APIs. The network interface(s) 1040 may support 3GPP reference points, such as Uu, N1, N2, N3, N5, N6 and/or N7 interfaces. Other network interfaces 1040 may be supported, as understood by one of ordinary skill in the art.

The processor 1005, in one embodiment, may include any known controller capable of executing computer-readable instructions and/or capable of performing logical operations. For example, the processor 1005 may be a microcontroller, a microprocessor, a central processing unit (“CPU”), a graphics processing unit (“GPU”), an auxiliary processing unit, a field programmable gate array (“FPGA”), a digital signal processor (“DSP”), a co-processor, an application-specific processor, or similar programmable controller. In some embodiments, the processor 1005 executes instructions stored in the memory 1010 to perform the methods and routines described herein. The processor 1005 is communicatively coupled to the memory 1010, the input device 1015, the output device 1020, and the transceiver 1025. In certain embodiments, the processor 1005 may include an application processor (also known as “main processor”) which manages application-domain and operating system (“OS”) functions and a baseband processor (also known as “baseband radio processor”) which manages radio function [[delete if network apparatus 1000 is not a RAN node/gNB/etc.]] In various embodiments, the processor 1005 controls the network apparatus 1000 to implement the above described network entity behaviors (e.g., of the gNB) for reliable industrial internet of things transmissions.

The memory 1010, in one embodiment, is a computer readable storage medium. In some embodiments, the memory 1010 includes volatile computer storage media. For example, the memory 1010 may include a RAM, including dynamic RAM (“DRAM”), synchronous dynamic RAM (“SDRAM”), and/or static RAM (“SRAM”). In some embodiments, the memory 1010 includes non-volatile computer storage media. For example, the memory 1010 may include a hard disk drive, a flash memory, or any other suitable non-volatile computer storage device. In some embodiments, the memory 1010 includes both volatile and non-volatile computer storage media.

In some embodiments, the memory 1010 stores data relating to reliable industrial internet of things transmissions. For example, the memory 1010 may store parameters, configurations, resource assignments, policies, and the like as described above. In certain embodiments, the memory 1010 also stores program code and related data, such as an operating system (“OS”) or other controller algorithms operating on the network apparatus 1000, and one or more software applications.

The input device 1015, in one embodiment, may include any known computer input device including a touch panel, a button, a keyboard, a stylus, a microphone, or the like. In some embodiments, the input device 1015 may be integrated with the output device 1020, for example, as a touchscreen or similar touch-sensitive display. In some embodiments, the input device 1015 includes a touchscreen such that text may be input using a virtual keyboard displayed on the touchscreen and/or by handwriting on the touchscreen. In some embodiments, the input device 1015 includes two or more different devices, such as a keyboard and a touch panel.

The output device 1020, in one embodiment, may include any known electronically controllable display or display device. The output device 1020 may be designed to output visual, audible, and/or haptic signals. In some embodiments, the output device 1020 includes an electronic display capable of outputting visual data to a user. Further, the output device 1020 may be a component of a smart phone, a personal digital assistant, a television, a table computer, a notebook (laptop) computer, a personal computer, a vehicle dashboard, or the like.

In certain embodiments, the output device 1020 includes one or more speakers for producing sound. For example, the output device 1020 may produce an audible alert or notification (e.g., a beep or chime). In some embodiments, the output device 1020 includes one or more haptic devices for producing vibrations, motion, or other haptic feedback. In some embodiments, all, or portions of the output device 1020 may be integrated with the input device 1015. For example, the input device 1015 and output device 1020 may form a touchscreen or similar touch-sensitive display. In other embodiments, all, or portions of the output device 1020 may be located near the input device 1015.

As discussed above, the transceiver 1025 may communicate with one or more remote units and/or with one or more interworking functions that provide access to one or more PLMNs. The transceiver 1025 may also communicate with one or more network functions (e.g., in the mobile core network 80). The transceiver 1025 operates under the control of the processor 1005 to transmit messages, data, and other signals and also to receive messages, data, and other signals. For example, the processor 1005 may selectively activate the transceiver (or portions thereof) at particular times in order to send and receive messages.

The transceiver 1025 may include one or more transmitters 1030 and one or more receivers 1035. In certain embodiments, the one or more transmitters 1030 and/or the one or more receivers 1035 may share transceiver hardware and/or circuitry. For example, the one or more transmitters 1030 and/or the one or more receivers 1035 may share antenna(s), antenna tuner(s), amplifier(s), filter(s), oscillator(s), mixer(s), modulator/demodulator(s), power supply, and the like. In one embodiment, the transceiver 1025 implements multiple logical transceivers using different communication protocols or protocol stacks, while using common physical hardware.

In one embodiment, the transceiver 1025 receives a transport block (“TB”) from a first device, the TB intended for a second device communicatively connected to the apparatus and the first device in a ring topology. In one embodiment, the processor 1005 determines an identifier for the second device based on the TB. In one embodiment, the transceiver 1025 transmits the TB to the identified second device over a new radio (“NR”) Uu interface.

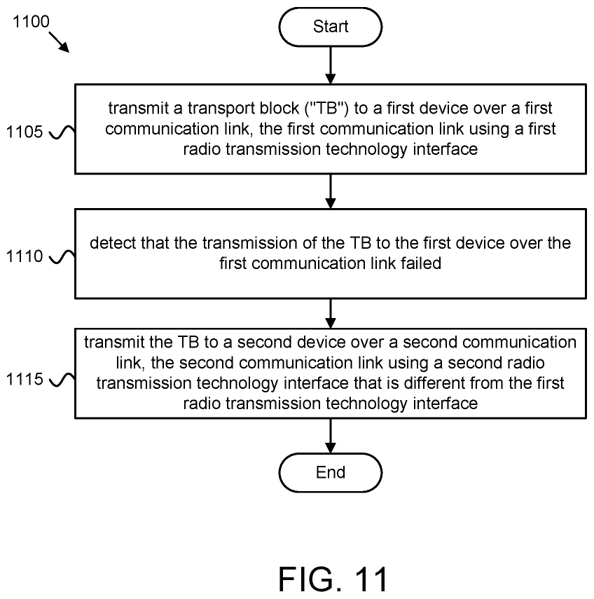

FIG. 11 is a flowchart diagram of a method 1100 for reliable industrial internet of things transmissions. The method 1100 may be performed by a UE as described herein, for example, the remote unit 105 and/or the user equipment apparatus 900. In some embodiments, the method 1100 may be performed by a processor executing program code, for example, a microcontroller, a microprocessor, a CPU, a GPU, an auxiliary processing unit, a FPGA, or the like.

In one embodiment, the method 1100 begins and transmits 1105 a transport block (“TB”) to a first device over a first communication link, the first communication link using a first radio transmission technology interface. In one embodiment, the method 1100 detects 1110 that the transmission of the TB to the first device over the first communication link failed. In one embodiment, in response to detecting that the transmission of the TB to the first device over the first communication link failed, the method 1100 transmits 1115 the TB to a second device over a second communication link, the second communication link using a second radio transmission technology interface that is different from the first radio transmission technology interface, and the method 1100 ends.

A first apparatus is disclosed for reliable industrial internet of things transmissions. The first apparatus may be performed by a UE as described herein, for example, the remote unit 105 and/or the user equipment apparatus 900. In some embodiments, the first apparatus may be performed by a processor executing program code, for example, a microcontroller, a microprocessor, a CPU, a GPU, an auxiliary processing unit, a FPGA, or the like.

A first apparatus includes a transceiver that transmits a transport block (“TB”) to a first device over a first communication link, the first communication link using a first radio transmission technology interface, detects that the transmission of the TB to the first device over the first communication link failed, and in response to detecting that the transmission of the TB to the first device over the first communication link failed, transmits the TB to a second device over a second communication link, the second communication link using a second radio transmission technology interface that is different from the first radio transmission technology interface.

In one embodiment, the first radio transmission technology interface is a new radio (“NR”) sidelink (“SL”) PC5 interface and the second radio transmission technology interface is a NR Uu interface.

In one embodiment, the first device is a user equipment (“UE”) that is communicatively connected to the apparatus and the second device is a base unit that is communicatively connected to the apparatus and one or more additional apparatuses.

In one embodiment, the transceiver transmits the TB to the second device using a new medium access control (“MAC”) control element (“CE”), the MAC CE comprising an identifier for the first device that is the intended recipient of the TB.

In one embodiment, the new MAC CE comprises a field indicating to the second device to forward the TB to the identifier for the first device.

In one embodiment, the first apparatus includes a processor that maps the new MAC CE to a scheduling request (“SR”) configuration for requesting SL resources for transmitting the new MAC CE to the second device.

In one embodiment, the processor triggers the SR in response to determining that the apparatus does not have valid SL resources available for transmitting the new MAC CE to the second device.

In one embodiment, the processor uses a contention free random access to seek resources for transmitting the new MAC CE to the second device.

In one embodiment, the transceiver receives a preconfiguration of resources for transmitting the TB to the second device based on an expected round trip time (“RTT”) for receiving a response from the first device.

In one embodiment, the transceiver transmits, on resources allocated by the second device, an indication to the second device that the transmission of the TB to the first device over the first communication link failed.

In one embodiment, the transmission failure indication comprises a medium access control (“MAC”) control element (“CE”), the MAC CE linked to at least one scheduling request (“SR”) configuration.

In one embodiment, the first communication link and the second communication link are operated by a multi-radio access technology (“RAT”) split bearer, wherein the multi-RAT bearer is comprised of a first new radio (“NR”) radio link control (“RLC”) bearer and a second PC5 RLC bearer.

In one embodiment, the first and second bearers are associated with a common SL packet data convergence protocol (“PDCP”) entity.

In one embodiment, the transceiver transmits the TB over the first communication link and the second communication link simultaneously.

In one embodiment, the transceiver transmits every N^{th} TB over the first communication link and the second communication link simultaneously.

In one embodiment, the transceiver transmits the TB over the first communication link and the second communication link simultaneously in response to channel measurements between the transceiver and the first device indicating transmitting the TB over the first communication link and the second communication link.

In one embodiment, the TB comprises an EtherCAT frame.

A first method is disclosed for reliable industrial internet of things transmissions. The first method may be performed by a UE as described herein, for example, the remote unit 105 and/or the user equipment apparatus 900. In some embodiments, the first method may be performed by a processor executing program code, for example, a microcontroller, a microprocessor, a CPU, a GPU, an auxiliary processing unit, a FPGA, or the like.

A first method transmits a transport block (“TB”) to a first device over a first communication link, the first communication link using a first radio transmission technology interface, detects that the transmission of the TB to the first device over the first communication link failed, and in response to detecting that the transmission of the TB to the first device over the first communication link failed, transmits the TB to a second device over a second communication link, the second communication link using a second radio transmission technology interface that is different from the first radio transmission technology interface.

In one embodiment, the first radio transmission technology interface is a new radio (“NR”) sidelink (“SL”) PC5 interface and the second radio transmission technology interface is a NR Uu interface.

In one embodiment, the first device is a user equipment (“UE”) that is communicatively connected to the apparatus and the second device is a base unit that is communicatively connected to the apparatus and one or more additional apparatuses.

In one embodiment, the first method transmits the TB to the second device using a new medium access control (“MAC”) control element (“CE”), the MAC CE comprising an identifier for the first device that is the intended recipient of the TB.

In one embodiment, the new MAC CE comprises a field indicating to the second device to forward the TB to the identifier for the first device.

In one embodiment, the first method maps the new MAC CE to a scheduling request (“SR”) configuration for requesting SL resources for transmitting the new MAC CE to the second device.

In one embodiment, the first method triggers the SR in response to determining that the apparatus does not have valid SL resources available for transmitting the new MAC CE to the second device.

In one embodiment, the first method uses a contention free random access to seek resources for transmitting the new MAC CE to the second device.

In one embodiment, the first method receives a preconfiguration of resources for transmitting the TB to the second device based on an expected round trip time (“RTT”) for receiving a response from the first device.

In one embodiment, the first method transmits, on resources allocated by the second device, an indication to the second device that the transmission of the TB to the first device over the first communication link failed.

In one embodiment, the transmission failure indication comprises a medium access control (“MAC”) control element (“CE”), the MAC CE linked to at least one scheduling request (“SR”) configuration.

In one embodiment, the first communication link and the second communication link are operated by a multi-radio access technology (“RAT”) split bearer, wherein the multi-RAT bearer is comprised of a first new radio (“NR”) radio link control (“RLC”) bearer and a second PC5 RLC bearer.

In one embodiment, the first and second bearers are associated with a common SL packet data convergence protocol (“PDCP”) entity.

In one embodiment, the first method transmits the TB over the first communication link and the second communication link simultaneously.

In one embodiment, the first method transmits every N^{th} TB over the first communication link and the second communication link simultaneously.

In one embodiment, the first method transmits the TB over the first communication link and the second communication link simultaneously in response to channel measurements between the transceiver and the first device indicating transmitting the TB over the first communication link and the second communication link.

In one embodiment, the TB comprises an EtherCAT frame.

A second apparatus is disclosed for reliable industrial internet of things transmissions. The second apparatus may be performed by a network device as described herein, for example, the base unit 121 and/or the network equipment apparatus 1000. In some embodiments, the second apparatus may be performed by a processor executing program code, for example, a microcontroller, a microprocessor, a CPU, a GPU, an auxiliary processing unit, a FPGA, or the like.

In one embodiment, a second apparatus includes a transceiver that receives a transport block (“TB”) from a first device, the TB intended for a second device communicatively connected to the apparatus and the first device in a ring topology and a processor that determines an identifier for the second device based on the TB. In one embodiment, the transceiver transmits the TB to the identified second device over a new radio (“NR”) Uu interface.

A second method is disclosed for reliable industrial internet of things transmissions. The second method may be performed by a network device as described herein, for example, the base unit 121 and/or the network equipment apparatus 1000. In some embodiments, the second method may be performed by a processor executing program code, for example, a microcontroller, a microprocessor, a CPU, a GPU, an auxiliary processing unit, a FPGA, or the like.

In one embodiment, a second method receives a transport block (“TB”) from a first device, the TB intended for a second device communicatively connected to the apparatus and the first device in a ring topology, determines an identifier for the second device based on the TB, and transmits the TB to the identified second device over a new radio (“NR”) Uu interface.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. A network equipment (NE) for wireless communication, comprising:
at least one memory; and
at least one processor coupled with the at least one memory and configured to cause the NE to:
transmit a transport block (“TB”) to a first device over a first communication link associated with a first radio access technology interface;
detect that the transmission of the TB failed; and
in response to detecting that the transmission of the TB failed, transmit the TB to a second device over a second communication link associated with a second radio access technology interface that is different from the first radio access technology interface.

2. The NE of claim 1, wherein the first radio access technology interface comprises a new radio (“NR”) sidelink (“SL”) PC5 interface and the second radio access technology interface comprises a NR Uu interface.

3. The NE of claim 1, wherein the first device is a user equipment (“UE”) that is communicatively connected to the NE and the second device is a base unit that is communicatively connected to the NE and one or more additional NEs.

4. The NE of claim 1, wherein the at least one processor is configured to cause the NE to transmit the TB to the second device using a medium access control (“MAC”) control element (“CE”), the MAC CE comprising an identifier for the first device that is an intended recipient of the TB.

5. The NE of claim 4, wherein the MAC CE comprises a field indicating to the second device to forward the TB to the first device as indicated by the identifier for the first device.

6. The NE of claim 4, wherein the at least one processor is configured to cause the NE to map the MAC CE to a scheduling request (“SR”) configuration for requesting SL resources for transmitting the MAC CE to the second device.

7. The NE of claim 6, wherein the at least one processor is configured to cause the NE to trigger the SR in response to determining that the NE does not have valid SL resources available for transmitting the MAC CE to the second device.

8. The NE of claim 1, wherein the at least one processor is configured to cause the NE to transmit, on resources allocated by the second device, an indication to the second device that the transmission of the TB to the first device over the first communication link failed.

9. The NE of claim 8, wherein the indication that the transmission of the TB to the first device failed comprises a medium access control (“MAC”) control element (“CE”), the MAC CE linked to at least one scheduling request (“SR”) configuration.

10. The NE of claim 1, wherein the first communication link and the second communication link are operated by a multi-radio access technology (“RAT”) split bearer and wherein the multi-RAT split bearer comprises a first new radio (“NR”) radio link control (“RLC”) bearer and a second PC5 RLC bearer.

11. The NE of claim 10, wherein the first NR RLC bearer and the second PC5 RLC bearer are associated with a common SL packet data convergence protocol (“PDCP”) entity.

12. The NE of claim 11, wherein the at least one processor is configured to cause the NE to transmit every Nth TB over the first communication link and the second communication link simultaneously.

13. The NE of claim 1, wherein the TB comprises an EtherCAT frame.

14. A method, comprising:
transmitting a transport block (“TB”) to a first device over a first communication link associated with a first radio access technology interface;
detecting that the transmission of the TB failed; and
in response to detecting that the transmission of the TB failed, transmitting the TB to a second device over a second communication link associated with a second radio access technology interface different from the first radio access technology interface.

15. A network equipment (NE) for wireless communication, comprising:
at least one memory; and
at least one processor coupled with the at least one memory and configured to cause the NE to:
receive a transport block (“TB”) from a first device, the TB intended for a second device communicatively connected to the NE and the first device in a ring topology;
determine an identifier for the second device based on the TB; and
transmit the TB to the identified second device over a new radio (“NR”) Uu interface.

16. A processor for wireless communication, comprising:
at least one controller coupled with at least one memory and configured to cause the processor to:
transmit a transport block (“TB”) to a first device over a first communication link associated with a first radio access technology interface;
detect that the transmission of the TB failed; and
in response to detecting that the transmission of the TB failed, transmit the TB to a second device over a second communication link associated with a second radio access technology interface that is different from the first radio access technology interface.

17. The processor of claim 16, wherein the first radio access technology interface is a new radio (“NR”) sidelink (“SL”) PC5 interface and the second radio access technology interface is a NR Uu interface.

18. The processor of claim 16, wherein the first device is a user equipment (“UE”) that is communicatively connected to the processor and the second device is a base unit that is communicatively connected to the processor and one or more additional processors.

19. The processor of claim 16, wherein the at least one controller is configured to cause the processor to transmit the TB to the second device using a medium access control (“MAC”) control element (“CE”), the MAC CE comprising an identifier for the first device that is the intended recipient of the TB.

20. The processor of claim 16, wherein the MAC CE comprises a field indicating to the second device to forward the TB to the first device as indicated by the identifier for the first device.
